(19) United States
(12) Patent Application Publication
(10) Pub. No.: US 2005/0010470 A1
(43) Pub. Date: Jan. 13, 2005

(54) Collaborative marketing mangement systems

(76) Inventor: Annette Marino, Scottsdale, AZ (US)

Correspondence Address: STONEMAN LAW OFFICES, LTD, 3113 NORTH 3RD STREET, PHOENIX, AZ, 85012, US

(21) Appl. No.: 10/886,297

(22) Filed: Jul. 6, 2004

Related U.S. Application Data
(60) Provisional application No. 60/485,387, filed on Jul. 9, 2003.

(51) Int. Cl. G06F 17/60; B65D 75/00; B65D 85/40

(52) U.S. Cl. 705/10

(57) ABSTRACT

Collaborative marketing systems for creating and streamlining effective and privacy-protected partner marketing opportunities for companies. They permit companies to become members of a partnership network of companies to gain exposure to customers of some of the other members companies' customers, yet keep their own customer database private. Each member agrees to introduce other member companies to their customers and can request to be introduced to the customers of other members as part of a defined event awareness initiative which may be implemented through email, direct mail or any other communication method. Provided are systems to promote rapid and continued growth of the partnership network and therefore marketing opportunities for members including cost sharing, event awareness initiative scheduling, planning and execution, and results tracking. The systems simplify, automate, standardize and leverage marketing partnership processes and are also intended to create and manage multiple networks of participating companies.

### CROSS-REFERENCE TO RELATED APPLICATION

The present application claims priority from and is related to prior provisional application Ser. No. 60/485,387, filed Jul. 7, 2003, entitled “PARTNER MARKETING SYSTEM AND METHOD”, the contents of which are incorporated herein by this reference and are not admitted to be prior art with respect to the present invention by the mention in this cross-reference section.

### BACKGROUND

The invention generally relates to collaborative marketing management systems. More particularly, it relates to a method and system that enables companies to more easily create and manage marketing partnerships with each other to be introduced to each other's customers while keeping their database of customers secure and private.

Many companies will not typically allow other companies to market directly to their highly-valuable customers through the use of their customer database; yet they desire to have access to similar databases of other companies in order to, for example, grow their business. Additionally, these companies often recognize the value of partnering to create promotions that highlight complementary services to their customers; yet it is usually very time-consuming to form these partnerships for a single promotion. For example, it may be highly desirable for one company to introduce to their customers to the complementary product or services of another company with a similar target market. However, the marketing departments of these companies do not usually have the resources to coordinate more than a rare occurrence of these types of partnerships/collaborations.

It is desirable for one company to identify a complementary company with whom it would like to coordinate a marketing partnership. An initiating company might champion the marketing partnership and first gain buy-in and approval (to begin to start the marketing partnership process). The initiating company might then identify who it should work with at the other company to coordinate such a partnership. Unfortunately, this part of the process would be very time-consuming and frustrating, which might result in many marketing partnership ideas ending at this point in the relationship because the initiating company might not have the resources to devote to the process. In cases where the initiating company is able to connect with the right person at the other company, there may be several phone calls and/or meetings needed to lay the groundwork for the marketing partnership, all of which might consume considerable time and effort. Once the groundwork may be set, the contact at the company that has been approached to participate in the marketing partnership must then get approval from their company to participate in the marketing partnership. Again, this is likely to be yet another time-consuming step in the process. Provided the marketing partnership is approved by both companies, resources from both companies might need to be applied to coordinate the tactical implementation of the partnership. Typically, managing and implementing a marketing partnership is not the core competency of either company; and consequently many of these projects might run into time and budget overruns, which is not only frustrating but can have a negative impact on the overall marketing plans of one or both of the partner companies. For example, the window for time-sensitive offers can be missed when a campaign misses its planned start date. Finally, even if a co-promotion is completed, there might be few or no standardized ways of tracking the results from the initiative and both companies might be left wondering what real value the marketing partnership provided.

Due to such issues that companies might encounter when trying to implement marketing partnerships, these partnerships might at best end up as single, unique initiatives; and all or any portion of the work may be sent to a storage file and not leveraged in a marketing partnership with a different company. Therefore, companies may be reluctant to spend time exploring marketing partner opportunities as set forth above even though they are often looking for ways to reach additional target markets. Advertising agencies might be used to assist their clients with marketing partnership initiatives; however, the core business of agencies is media sales.

Recently, a wide range of interactive devices has been developed to provide information to a variety of users via communications networks such as the Internet. These interactive devices include, for example, computers connected to various computer on-line services, interactive kiosks, interactive television systems, a variety of other wired and wireless devices, such as personal data assistants (PDA's), and the like. In particular, the popularity of computer on-line services has grown immensely in popularity over the last decade. Computer on-line services are provided by a wide variety of different companies.

In general, most computer on-line services are accessed via the Internet. The Internet is a global network of computers. One popular part of the Internet is the World Wide Web, or the “Web.” The World Wide Web contains computers that display graphical and textual information. Computers that provide information on the World Wide Web are typically called “Web sites.” A Web site is defined by an Internet address that has an associated electronic page, often called a “home page.” Generally, a home page is an electronic document that organizes the presentation of text, graphical images, audio and video into a desired display. These Web sites are operated by a wide variety of entities, which are typically called “providers.”

A user may access the Internet via a dedicated high-speed line or by using a personal computer (PC) equipped with a conventional modem or a variety of other wired and wireless devices. Special interface software, called “browser” software, is installed within the PC or other access device. When the user wishes to access the Internet by normal telephone line, an attached modem is automatically instructed to dial the telephone number associated with the local Internet host server. The user can then access information at any address accessible over the Internet. Two well-known web browsers, for example, are the Netscape Navigator browser marketed by Netscape Communications Corporation and the Internet Explorer browser marketed by Microsoft Corporation.

Information exchanged over the Internet is typically encoded in HyperText Mark-up Language (HTML) format. The HTML format is a scripting language that is used to generate the home pages for different content providers. In this setting, a content provider is an individual or company that places information (content) on the Internet so that others can access it. As is well known in the art, the HTML format is a set of conventions for marking different portions of a document so that each portion appears in a distinctive format. For example, the HTML format identifies or “tags” portions of a document to identify different categories of text (e.g., the title, header, body text, etc.). When a web browser accesses an HTML document, the web browser reads the embedded tags in the document so it appears formatted in the specified manner.

An HTML document can also include hyperlinks, which allow a user to move from one document to another document on the Internet. A hyperlink is an underlined or otherwise emphasized portion of text that, when selected using an input device such as a mouse, activates a software connection module that allows the user to jump between documents or pages (i.e., within the same Web site or to other Web sites). Hyperlinks are well known in the art, and have been sometimes referred to as anchors. The act of selecting the hyperlink is often referred to as “clicking on” the hyperlink.

Accordingly, a system is needed to automate, standardize and leverage process steps involved in a collaborative marketing partnership.

### OBJECTS AND FEATURES OF THE INVENTION

A primary object and feature of the present invention is to overcome the above-mentioned problems and fill the above-mentioned needs. Another such object and feature is to provide a system for creating and streamlining effective and privacy-protected partner marketing opportunities for companies.

Another object and feature of the present invention is to assist companies to become clients of a managed collaborative marketing business so that they can gain exposure to other companies' customers yet keep their own customer database private.

It is yet another object and feature of the present invention to create and manage multiple marketing networks of participating member companies to facilitate inter-network cooperation and growth.

Furthermore, it is an object and feature of the present invention to provide processes and systems to promote rapid and continued growth of each marketing network.

It is yet another primary objective and feature of the present invention to facilitate and promote the creation of shared marketing opportunities for members of the managed collaborative marketing business.

Still another primary objective and feature of the present invention is to enable cost sharing amongst members of the managed collaborative marketing business participating in a shared marketing initiative. Additionally, it is an objective and feature of the present invention to provide marketing initiative scheduling, planning and execution, and results tracking for members participating in a marketing initiative.

A further primary objective and feature of the present invention is to communicate marketing initiative opportunities to the members of each marketing network;

Another primary objective and feature of the present invention is coordinate and manage all or any portion of marketing initiatives including requests for inclusion by members, and/or acceptance or rejection of these requests by members.

Furthermore, it is another primary objective and feature of the present invention to coordinate preparation of creative designs, production of marketing materials, sign-offs, and launch of each marketing initiative to help ensure that goals of a marketing initiative are accomplished.

Another primary objective and feature of the present invention is to provide reporting to marketing initiative participants of the specific marketing initiative results that are pertinent to each participant.

Still another primary objective and feature of the present invention is to assess and collect fees and usage credits previously earned and to calculate new credits earned for a marketing initiative.

It is another primary objective and feature of the present invention that members agree to introduce other member companies to their customers in their customer database and permit members to request to be introduced to the customers of other member companies.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a collaborative marketing management system, relating to at least one managed collaborative marketing business, comprising the steps of: acquiring at least one profile from at least one plurality of potential members; receiving at least one marketing agreement each from such at least one plurality of potential members; approving such received marketing agreements, wherein members are determinable; determining at least one first such identity-known member desiring to send at least one shared marketing message, shared with at least one other second identity-unknown member, to at least one plurality of proposed recipients; and determining an identity of at least one sharing second member desiring to join such at least one shared marketing message to be sent to such at least one plurality of proposed recipients. Moreover, it provides such a collaborative marketing management system further comprising the steps of: receiving at least one marketing calendar from such at least one first member; wherein such at least one marketing calendar comprises: at least one topic of such at least one shared marketing message, and at least one scheduled delivery of such at least one shared marketing message for such at least one topic; acquiring at least one first marketing message from such at least one first member; acquiring at least one second marketing message from such at least one sharing second member; combining such at least one first marketing message and such at least one second marketing message into such at least one shared marketing message; selecting such at least one plurality of recipients of such at least one shared marketing message from such at least one plurality of proposed recipients; and sending such at least one shared marketing message to such at least one plurality of recipients. Additionally, it provides such a collaborative marketing management system further comprising the steps of: calculating at least one amount to be paid by such at least one participating second member; calculating at least one benefit amount attributable to such at least one first member; and receiving such at least one calculated amount from such at least one participating second member. Also, it provides such a collaborative marketing management system further comprising the steps of: retaining as operating profit at least one portion of such at least one calculated amount. In addition, it provides such a collaborative marketing management system, wherein such at least one shared marketing message comprises electronic mail, further comprising the steps of: recording the number of such at least one shared marketing messages sent; recording the number of sent such at least one shared marketing messages responded to by such at least one recipient; recording the number of sent such at least one first marketing messages responded to by such at least one recipient; recording the number of sent such at least one second marketing messages responded to by such at least one recipient reporting to such at least one first member confidentially the number of such at least one first marketing messages responded to by such at least one recipient; and reporting to such at least one second member confidentially the number of such at least one second marketing messages responded to by such at least one recipient. And, it provides such a collaborative marketing management system wherein such at least one plurality of recipients are entities known to such at least one first member. Further, it provides such a collaborative marketing management system wherein such at least one plurality of recipients comprises: entities known to such at least one first member; or entities known to such at least one second member; or entities known to both such at least one first member and such at least one second member. Even further, it provides such a collaborative marketing management system wherein such at least one marketing calendar further comprises: at least one count of estimated recipients of such at least one shared marketing message; and identity of such at least one sharing second member. Moreover, it provides such a collaborative marketing management system wherein the step of determining at least one second member desiring to join such at least one shared marketing message to be sent to such at least one plurality of proposed recipients comprises: publishing such at least one marketing calendar of such at least one first member; accepting requests to participate in such at least one scheduled delivery of such at least one shared marketing message for such at least one topic from such at least one second member; and selecting such at least one requesting second member for participation in such at least one scheduled delivery of such at least one shared marketing message for such at least one topic; issuing at least one invitation to participate in such at least one scheduled delivery of such at least one shared marketing message for such at least one topic to such at least one second member by such at least one first member; and accepting such at least one invitation to participate in such at least one scheduled delivery of such at least one shared marketing message for such at least one topic by such at least one second member. Additionally, it provides such a collaborative marketing management system further comprising the steps of: preparing at least one initiative agreement for each such at least one scheduled delivery of such at least one shared marketing message for such at least one topic; wherein such at least one initiative agreement comprises at least one schedule of completion dates of at least one manager task, at least one schedule of completion dates of at least one first member task, at least one schedule of completion dates of at least one second member task, at least one calculation basis for amount due from such at least one participating second member, at least one amount due from such at least one participation second member, and at least one benefit amount due to such at least one first member; agreeing to complete such at least one first member task by such at least one first member; agreeing to complete such at least one second member task by such at least one second member; and agreeing to complete such at least one manager task by such at least one manager. Also, it provides such a collaborative marketing management system further comprising the steps of: providing marketing calendar planning assistance to such at least one first member by such at least one manager; providing design assistance for at least one first marketing message by such at least one manager; providing design assistance for at least one second marketing message by such at least one manager; and managing completion of such at least one initiative agreement by such at least one manager. In addition, it provides such a collaborative marketing management system, wherein the step of approving such received marketing agreements, wherein members are determinable, comprises the steps of: approving agreeing to comply with at least one manager requirement by at least one manager of such at least one managed collaborative marketing business; wherein such at least one manager requirement comprises maintaining all such known entities of such at least one member as confidential, and approving agreeing to comply with at least one member requirement by such at least one potential member; wherein such at least one member requirement comprises permitting the use of at least one creative element by such at least one manager, agreement to comply with at least one requirement of at least one initiative agreement. And, it provides such a collaborative marketing management system, wherein the step of combining such at least one first marketing message and such at least one second marketing message into such at least one shared marketing message is completed by such at least one manager. Further, it provides such a collaborative marketing management system, wherein the step of sending such at least one shared marketing message to such at least one plurality of recipients is completed by such at least one manager. Even further, it provides such a collaborative marketing management system further comprising the step of receiving payment of at least one initial registration fee each from such at least one plurality of potential members. Moreover, it provides such a collaborative marketing management system wherein such at least one managed collaborative marketing business is regionally organized.

In accordance with another preferred embodiment hereof, this invention provides a collaborative marketing management system for computer-managing at least one managed collaborative marketing business, comprising in combination: computer interface means for acquiring at least one profile from at least one plurality of potential members; computer interface means for permitting at least one first such identity-known member to send at least one shared marketing message, shared with at least one other second member, to at least one plurality of proposed recipients; and computer interface means for permitting at least one sharing second member desiring to join such at least one shared marketing message to be sent to such at least one plurality of proposed recipients. Additionally, it provides such a collaborative marketing management system further comprising: computer interface means for receiving at least one marketing calendar from such at least one first member; wherein such at least one marketing calendar comprises: at least one topic of such at least one shared marketing message, and at least one scheduled delivery of such at least one shared marketing message for such at least one topic; computer processor means for acquiring at least one first marketing message from such at least one first member; computer processor means for acquiring at least one second marketing message from such at least one sharing second member; computer processor means for combining such at least one first marketing message and such at least one second marketing message into such at least one shared marketing message; computer processor means for selecting such at least one plurality of recipients of such at least one shared marketing message from such at least one plurality of proposed recipients; and computer communication means for sending such at least one shared marketing message to such at least one plurality of recipients. Also, it provides such a collaborative marketing management system further comprising: computer processor means for calculating at least one amount to be paid by such at least one participating second member; computer processor means for calculating at least one benefit amount attributable to such at least one first member; and computer storage means for storing such at least one calculated amount from such at least one participating second member. In addition, it provides such a collaborative marketing management system, wherein such at least one shared marketing message comprises electronic mail, further comprising: computer processor means for recording the number of such at least one shared marketing messages sent; computer processor means for recording the number of sent such at least one shared marketing messages responded to by such at least one recipient; computer processor means for recording the number of sent such at least one first marketing messages responded to by such at least one recipient; and computer processor means for recording the number of sent such at least one second marketing messages responded to by such at least one recipient; computer processor means for reporting to such at least one first member confidentially the number of such at least one first marketing messages responded to by such at least one recipient; and computer processor means for reporting to such at least one second member confidentially the number of such at least one second marketing messages responded to by such at least one recipient. And, it provides such a collaborative marketing management system wherein such at least one plurality of recipients are entities known to such at least one first member. Further, it provides such a collaborative marketing management system wherein such at least one plurality of recipients consists essentially of: entities known to such at least one first member; or entities known to such at least one second member; or entities known to both such at least one first member and such at least one second member. Even further, it provides such a collaborative marketing management system wherein such at least one marketing calendar further comprises: at least one count of estimated recipients of such at least one shared marketing message; and identity of such at least one sharing second member. Moreover, it provides such a collaborative marketing management system wherein the computer interface means for permitting at least one sharing second member desiring to join such at least one shared marketing message to be sent to such at least one plurality of proposed recipients comprises: computer processor means for publishing such at least one marketing calendar of such at least one first member; computer interface means for accepting requests to participate in such at least one scheduled delivery of such at least one shared marketing message for such at least one topic from such at least one second member; and computer interface means for selecting such at least one requesting second member for participation in such at least one scheduled delivery of such at least one shared marketing message for such at least one topic; computer interface means for issuing at least one invitation to participate in such at least one scheduled delivery of such at least one shared marketing message for such at least one topic to such at least one second member by such at least one first member; and computer interface means for accepting such at least one invitation to participate in such at least one scheduled delivery of such at least one shared marketing message for such at least one topic by such at least one second member. Additionally, it provides such a collaborative marketing management system, wherein the computer processor means for combining such at least one first marketing message and such at least one second marketing message into such at least one shared marketing message is controlled by such at least one manager. Also, it provides such a collaborative marketing management system, wherein the computer communication means for sending such at least one shared marketing message to such at least one plurality of recipients is controlled by such at least one manager. In addition, it provides such a collaborative marketing management system, wherein such at least one managed collaborative marketing business is regionally organized.

In accordance with another preferred embodiment hereof, this invention provides a collaborative marketing management system computer program, relating to computer-managing at least one managed collaborative marketing business, comprising the steps of: storing at least one profile from at least one plurality of potential members; authorizing at least one first such identity-known member to send at least one shared marketing message, shared with at least one other second member, to at a one plurality of proposed recipients; and authorizing at least one sharing second member to join such at least one shared marketing message to be sent to such at least one plurality of proposed recipients. And, it provides such a collaborative marketing management system computer program further comprising the steps of: storing at least one marketing calendar from such at least one first member; wherein such at least one marketing calendar comprises: at least one topic of such at least one shared marketing message, and at least one scheduled delivery of such at least one shared marketing message for such at least one topic; storing at least one first marketing message from such at least one first member; storing at least one second marketing message from such at least one sharing second member; combining such at least one first marketing message and such at least one second marketing message into such at least one shared marketing message; selecting such at least one plurality of recipients of such at least one shared marketing message from such at least one plurality of proposed recipients; and sending such at least one shared marketing message to such at least one plurality of recipients. Further, it provides such a collaborative marketing management system computer program further comprising the steps of: calculating at least one amount to be paid by such at least one participating second member; calculating at least one benefit amount attributable to such at least one first member; and storing such at least one calculated amount from such at least one participating second member. Even further, it provides such a collaborative marketing management system computer program, wherein such at least one shared marketing message comprises electronic mail, further comprising: recording the number of such at least one shared marketing messages sent; recording the number of sent such at least one shared marketing messages responded to by such at least one recipient; recording the number of sent such at least one first marketing messages responded to by such at least one recipient; and recording the number of sent such at least one second marketing messages responded to by such at least one recipient; reporting to such at least one first member confidentially the number of such at least one first marketing messages responded to by such at least one recipient; and reporting to such at least one second member confidentially the number of such at least one second marketing messages responded to by such at least one recipient. Even further, it provides such a collaborative marketing management system computer program wherein such at least one plurality of recipients are entities known to such at least one first member. Even further, it provides such a collaborative marketing management system computer program wherein such at least one plurality of recipients consists essentially of: entities known to such at least one first member; or entities known to such at least one second member; or entities known to both such at least one first member and such at least one second member. Even further, it provides such a collaborative marketing management system computer program wherein such at least one marketing calendar further comprises: at least one count of estimated recipients of such at least one shared marketing message; and identity of such at least one sharing second member. Even further, it provides such a collaborative marketing management system computer program wherein the step of authorizing at least one sharing second member desiring to join such at least one shared marketing message to be sent to such at least one plurality of proposed recipients comprises the steps of: presenting such at least one marketing calendar of such at least one first member; accepting requests to participate in such at least one scheduled delivery of such at least one shared marketing message for such at least one topic from such at least one second member; and selecting such at least one requesting second member for participation in such at least one scheduled delivery of such at least one shared marketing message for such at least one topic; issuing at least one invitation to participate in such at least one scheduled delivery of such at least one shared marketing message for such at least one topic to such at least one second member by such at least one first member; and accepting such at least one invitation to participate in such at least one scheduled delivery of such at least one shared marketing message for such at least one topic by such at least one second member. Even further, it provides such a collaborative marketing management system computer program wherein the step of combining such at least one first marketing message and such at least one second marketing message into such at least one shared marketing message is controlled by such at least one manager. Even further, it provides such a collaborative marketing management system computer program wherein the step of sending such at least one shared marketing message to such at least one plurality of recipients is controlled by such at least one manager.

### BRIEF DESCRIPTION OF THE DRAWINGS

FIG. 1 is a diagrammatical overview of the computer hardware and Internet environment utilized by the present invention, according to a preferred embodiment of the present invention.

FIG. 2 is a simplified functional diagram illustrating a preferred web server implementation for operating the present invention, according to a preferred embodiment of the present invention.

FIG. 3 is a diagrammatical overview for delivery of a shared marketing message, according to a preferred embodiment of the present invention.

FIG. 4 is a diagrammatical overview for delivery of fund-raising shared marketing messages, according to a preferred embodiment of the present invention.

FIG. 5 is a diagrammatical overview for delivery of an inter-regionally oriented shared marketing message, according to a preferred embodiment of the present invention.

FIG. 6 is a diagrammatical overview of the primary steps for managing marketing introductions networks for delivery of shared marketing messages, according to a preferred embodiment of the present invention.

FIG. 7 is a diagrammatical overview of the primary steps for completing a Fund Raising Marketing Initiative, according to a preferred embodiment of the present invention.

FIG. 8 is a summary schematic illustrating the primary functional components of the partner marketing software system, according to the preferred embodiment of a present invention.

FIG. 9 is a diagrammatical overview illustrating the primary member desktop functions of the partner marketing software system, according to a preferred embodiment of the present invention.

FIG. 10 is an illustration of a sample partnership marketing agreement, according to a preferred embodiment of the present invention.

FIG. 11 is an illustration of a sample marketing initiative agreement, according to a preferred embodiment of the present invention.

FIG. 12 is a diagrammatical view, illustrating a shared marketing message, according to a preferred embodiment of the present invention.

FIG. 13 is a diagrammatical view, illustrating a sponsored event message, according to a preferred embodiment of the present invention.

FIG. 14 is an example of a marketing initiative screen, illustrating presentation of upcoming marketing initiatives and permitting partner to request participation as a guest, according to a preferred embodiment of the present invention.

FIG. 15 is an example of a partner's account summary screen, illustrating a partner's charges, payments and credit for participation in the network, according to a preferred embodiment of the present invention.

FIG. 16 is an example of a marketing initiative status screen, illustrating the results of delivery of a particular marketing message, according to the preferred embodiment of the present invention.

### GLOSSARY OF GENERAL TERMS AND ACRONYMS

The following terms and acronyms are explained below as background and are used throughout the detailed description:

Client-Server. A model of interaction in a distributed system in which a program at one site sends a request to a program at another site and waits for a response. The requesting program is called the “client,” and the program, which responds to the request, is called the “server.” In the context of the World Wide Web, the client is typically a “Web browser”, which runs on a user's computer; the program which responds to Web browser requests at a Web site is commonly referred to as a “Web server.”

Domain Name System (DNS). An Internet service that translates domain names (which are alphabetic identifiers) into IP addresses (which are numeric identifiers for machines on a TCP/IP network).

Internet Information Server (IIS). Microsoft Corporation's Web server that runs on Windows NT platforms.

Internet. A collection of interconnected (public and/or private) networks that are linked together by a set of standard protocols to form a distributed network. While this term is intended to refer to what is now commonly known as the Internet, it is also intended to encompass variations, which may be made in the future, including changes and additions to existing standard protocols.

HyperText Markup Language (HTML). A standard coding convention and set of codes for attaching presentation and linking attributes to informational content within documents. During a document authoring stage, the HTML codes (referred to as “tags”) are embedded within the informational content of the document. When the Web document (or “HTML document”) is subsequently transferred from a Web server to a Web browser, the codes are interpreted by the Web browser and used to parse and display the document. In addition to specifying how the Web browser is to display the document, HTML tags can be used to create links to other websites and other Web documents (commonly referred to as “hyperlinks”). For more information on HTML, see Ian S. Graham, The HTML Source Book, John Wiley and Sons, Inc., 1995 (ISBN 0471-11894-4).

HyperText Transport Protocol (HTTP). The standard World Wide Web client-server protocol used for the exchange of information (such as HTML documents, and client requests for such documents) between a Web browser and a Web server. HTTP includes a number of different types of messages that can be sent from the client to the server to request different types of server actions. For example, a “GET” message, which has the format GET, causes the server to return the document or file located at the specified Universal Resource Locator (URL).

Java. A general purpose programming language developed by Sun Microsystems. Java has a number of features that make the language well-suited for use on the World Wide Web. Small Java applications are called Java applets and can be downloaded from a Web server and run on a personal computer by a Java-compatible Web browser, such as Netscape Navigator or Microsoft Explorer.

Java Servlet. A small Java-based program designed to perform a specific task within a Web server environment. Java Servlets are analogous to Java applets except the are designed to only run on the Web server.

Java Virtual Machine. A set of applications that create a run time environment for executing Java code.

JRun. A server-side extension that allows a Web server to execute Java servlets for the processing and display of information. JRun is a widely adopted engine for developing and deploying server-side Java applications that use Java Servlets and JavaServer Pages (JSP).

Java Data Base Connectivity (JDBC). A Java API developed by JavaSoft, a subsidiary of Sun Microsystems of Mountain View, Calif. JDBC enables Java programs to execute SQL statements, which allows Java programs to interact with any SQL-compliant database. Since many relational database management systems (DBMSs) support SQL, and because Java itself runs on most platforms, JDBC makes it possible to write a single database application that can run on different platforms and interact with different database management systems. JDBC is similar to ODBC but is designed specifically for Java programs, whereas ODBC is language-independent.

LAN (Local Area Network)—This term is sometimes used herein to refer to a system that links together electronic office equipment, such as computers and word processors, and forms a network within an office or building.

Open Data Base Connectivity (ODBC). A database access method developed by Microsoft Corporation. ODBC allows an application to access data from a database by translating the application's data queries into commands that the database management system (DBMS) can understand.

PDA (Personal Digital Assistant)—This term is sometimes used herein to refer to a small hand held computer with or without wireless access to the Internet. A lightweight, hand-held, usually pen-based computer used as a personal organizer.

SOAP (Simple Object Access Protocol)—This term is sometimes used herein to refer to a lightweight protocol for exchange of information in a decentralized, distributed environment. It is an XML based protocol that consists of three parts: an envelope that defines a framework for describing what is in a message and how to process it, a set of encoding rules for expressing instances of application-defined data types, and a convention for representing remote procedure calls and responses. SOAP can potentially be used in combination with a variety of other protocols. World Wide Web Consortium definition (See http://www.w3.org/tr/soap).

Transmission Control Protocol/Internet Protocol (TCP/IP). A standard Internet protocol (or set of protocols) which specifies how two computers exchange data over the Internet. TCP/IP handles issues such as packetization, packet addressing, handshaking and error correction. For more information on TCP/IP, see Volumes I, II and III of Corner and Stevens, Internetworking with TCP/IP, Prentice Hall, Inc., ISBNs 0-13-468505-9 (vol. I), 0-13-125527-4 (vol. II), and 0-13-474222-2 (vol. III).

UML (Unified Modeling Language)—This term is sometimes used herein to refer to a graphical language for visualization, specifying, constructing, and documenting the artifacts of a software-intensive system. The UML gives you a standard way to write a system's blueprints, covering conceptual things, such as business processes and system functions, as well as concrete things, such as classes written in a specific programming language, database schemas, and reusable software components. The Unified Modeling Language User Guide: Grady Booch, James Rumbaugh, Ivar Jacobson. Addison-Wesley, Copyright 1999 ISBN 0-201-57168-4; The Unified Modeling Language Reference Manual: Grady Booch, James Rumbaugh, Ivar Jacobson. Addison-Wesley, Copyright 1999 ISBN 0-201-30998-X; UML In A Nutshell, A desktop quick reference: Sinan Si Alhir. O'Reilly & Associates, Inc., Copyright 1998 ISBN 1-56592-448-7; UML Distilled, second edition: Martin Fowler with Kendall Scott. Addison-Wesly, Copyright 2000 ISBN 0-201-65783-X.

Uniform Resource Locator (URL). A unique address which fully specifies the location of a file or other resource on the Internet. The general format of a URL is protocol://machine address:port/path/filename. The port specification is optional, and, if none is entered by the user, the Web browser defaults to the standard port for whatever service is specified as the protocol. For example, if HTTP is specified as the protocol, the Web browser will use the HTTP default port. The machine address in this example is the domain name for the computer or device on which the file is located.

WAN (Wide Area Network)—This term is sometimes used herein to refer to a communications network that uses such devices as telephone lines, satellite dishes, or radio waves to span a larger geographic area than can be covered by a LAN.

World Wide Web (“Web”). Used herein to refer generally to both (1) a distributed collection of interlinked, user-viewable hypertext documents (commonly referred to as “Web documents”, “Web pages”, “electronic pages” or “home pages”) that are accessible via the Internet, and (2) the client and server software components that provide user access to such documents using standardized Internet protocols. Currently, the primary standard protocol for allowing applications to locate and acquire Web documents is the HyperText Transfer Protocol (HTTP), and the electronic pages are encoded using the HyperText Markup Language (HTML). However, the terms “World Wide Web” and “Web” are intended to encompass future markup languages and transport protocols that may be used in place of or in addition to the HyperText Markup Language and the HyperText Transfer Protocol.

XML (Extensible Markup Language)—This term is sometimes used herein to refer to the universal format for structured documents and data on the Web. World Wide Web Consortium definition (See http://www.w3.org/XML/).

### DETAILED DESCRIPTION OF THE BEST MODES AND PREFERRED EMBODIMENTS OF THE INVENTION

In the accompanying drawings, well-known structures and devices are shown in block diagram form in order to provide an understanding of the interrelationship between components and the flow of information and control throughout the depicted preferred embodiment of the present invention. It will be apparent to one skilled in the art from the teachings herein that the invention may be practiced with a variety of different specific components/techniques, without detraction or departure from the scope of the present invention, provided to serve the generalized block diagram description. Specific statements made with respect to any of these operations are intended to clarify the nature of the operation being performed, but should not be taken as a limitation of the operation should an alternative operation be desired in a substantially similar situation or setting.

The detailed description of preferred embodiments of the invention herein makes reference to the accompanying drawings and screen shot simulations, which show the preferred embodiment by way of illustration and its best mode. While these preferred embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may not limited to the order presented and may at times be executed in any order.

As will be appreciated by one of ordinary skill in the art, many ideas of the present invention preferably may be embodied as a method, a data processing system, a device for data processing, and/or a computer program product. Accordingly, a preferred embodiment of the present invention may take the form of an entirely manual embodiment, an entirely software embodiment, an entirely hardware embodiment, or an embodiment combining aspects of any portion of software, hardware and/or manual operation. Furthermore, a preferred embodiment of the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

A preferred computer embodiment of the present invention is described herein with reference to screen shots, block diagrams and flowchart illustrations of methods, apparatus (e.g., systems), and computer program products according to various aspects of a preferred embodiment of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In addition, it is noted that the business methods of the present invention, although not computer inventions, may often be enabled and explained in a more teachable manner if described also in relation to some or all of the steps of the business method being computer-assisted.

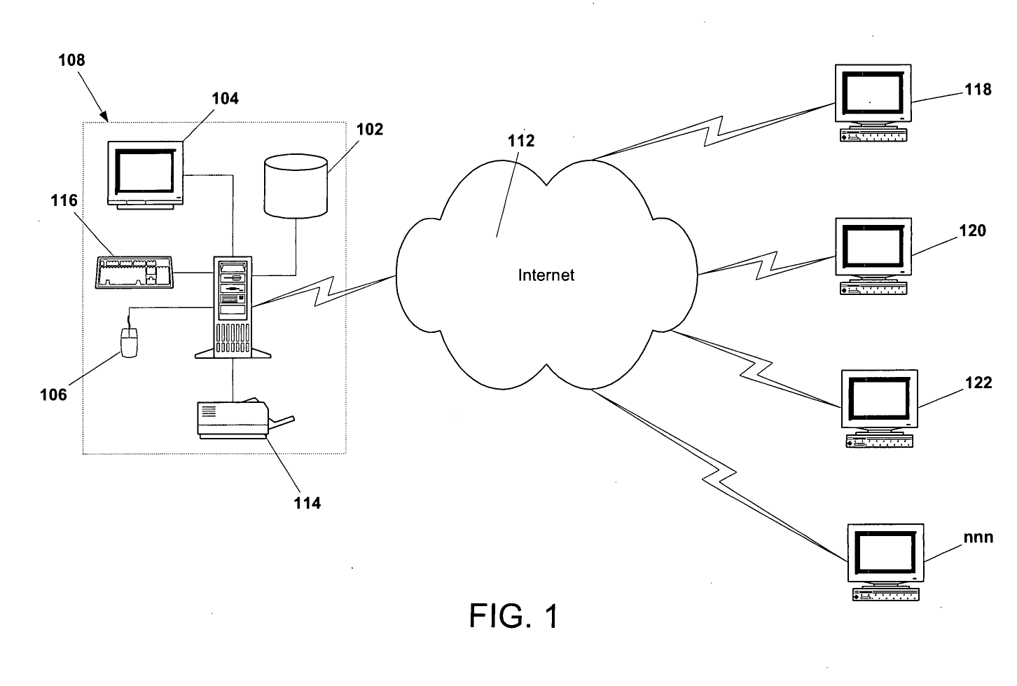

Referring now to FIG. 1, a diagrammatical overview of the computer hardware and Internet environment utilized by a preferred embodiment of the present invention is shown. The computer hardware environment comprises a computer system 108. The computer system 108 comprises input and output devices as is well known in the art. For example, the computer system 108 preferably comprises a display screen or monitor 104, a keyboard 116, a printer 114, a mouse 106, etc. The computer system 108 further preferably comprises a database 102 for storage of the data and software comprising preferred embodiments of the present invention. The computer system 108 is preferably connected to the Internet 112 which serves as the presently preferred communications medium. The Internet 112, as previously discussed, comprises a global network of networks and computers, public and private. The Internet 112 is the preferable connection method by the users 118, 120, 122 and nnn in preferred embodiments of the present invention.

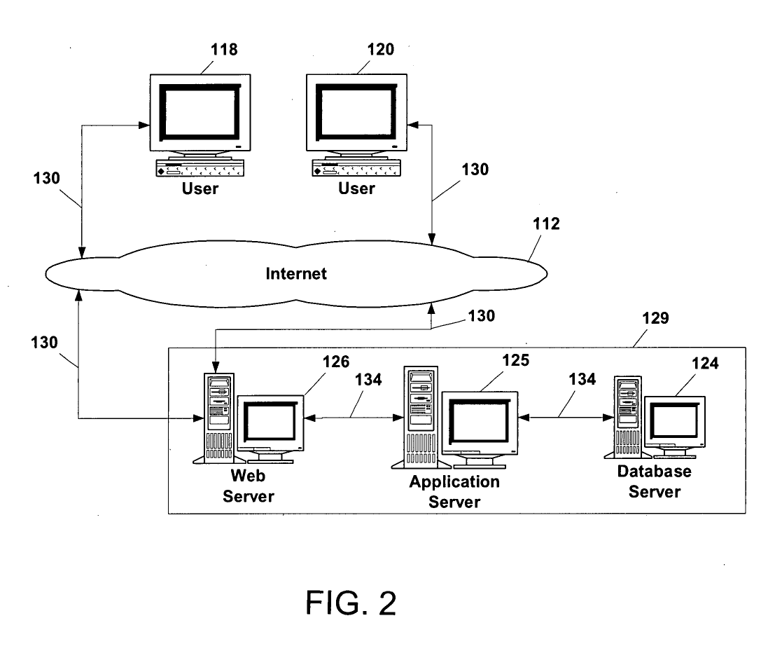

Referring to FIG. 2, a simplified functional diagram illustrating a preferred web server implementation for implementing a preferred embodiment of the present invention is shown. This figure shows the preferred relationships between a user 118 (as an example of any number of users 118, 120, 122, nnn), the Internet 112, the web server 126, the application server 125 and the database server 124. As shown, user 118 requests a page from the web site where a preferred embodiment of the present invention is preferably located. The user 118 is preferably connected via the Internet 112, to the web server 126 which receives the web page request and initiates a call to the application server 125. A preferred embodiment of the present invention installed on the application server 125 then makes at least one request to the database server 124, and generates an HTML page for transmission to the user 118 following completion of the present invention's request and transmission of the requested data back to the application server 125 by the database server 124. The web server 126 then transmits the completed HTML page containing the data requested by the user 118 through the Internet 112 to the user 118.

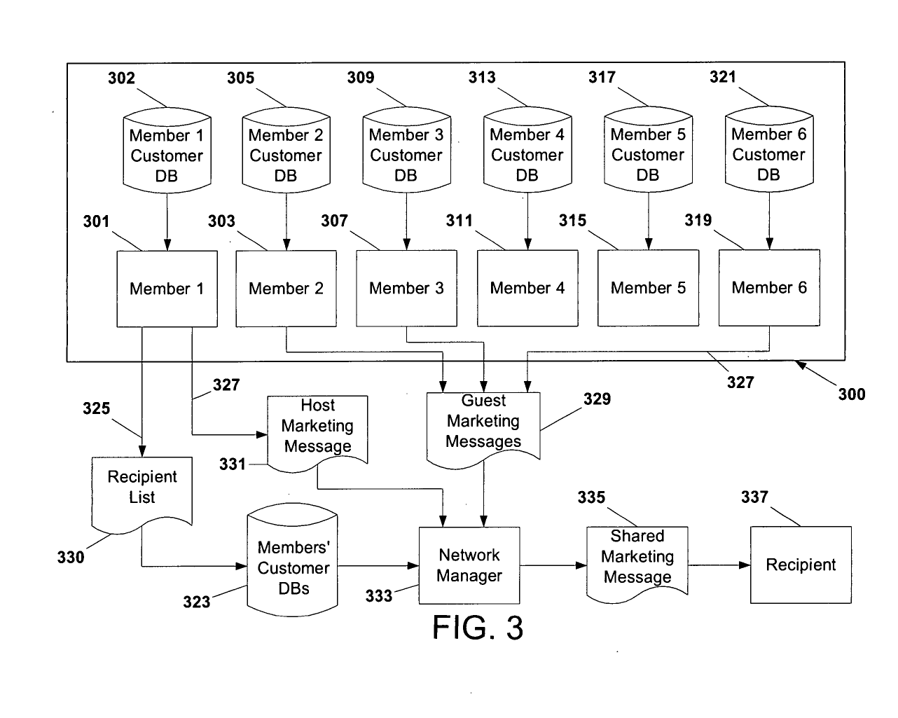

Referring to FIG. 3, a diagrammatical overview for delivery of a shared marketing message 335, according to a preferred embodiment of the present invention, illustrates the concept of creation and delivery of shared marketing message to a selected group of recipients 333 known to one member of a marketing introductions network 300. Preferably, the objectives of such a concept are to provide information about complementary products and services to recipients known to one partner and to permit other partners to be introduced to those recipients as a method of expanding their customer base. Preferably, member 1 301, member 2 303, member 3 307, member 4 311, member 5 315, and member 6 319 are members of marketing introductions network 300. As shown, member 1 301 is acting as the Host for the delivery of shared marketing message 335 because of its desire to send a shared marketing message 335 to individuals on its recipients list 330. Member 1 301 has preferably signified its desire for Guest participation in its shared marketing message 335 by announcing the topic and expected delivery date to all other members of the marketing introductions network 300. Preferably, as Host, member 1 301 provides a recipient list 330 from its member 1 customer DB 302 to the network manager 333 in database transfer process 325 which is then preferably stored confidentially in members' customer DBs 323. Most preferably, the recipient list 330 comprises a list of customers of member 1 301 and people known to member 1 301; but alternately the list of recipients comprises people not known to member 1 301. Preferably, the network manager 333 keeps recipient list 330 confidential and does not permit disclosure to other members. Additionally, as shown, preferably member 1 301 provides the host marketing message 331 to the network manager 333.

According to a preferred embodiment of the present invention, member 2 303, member 3 307 and member 6 319 act as Guests for the delivery of shared marketing message 335. In this example, member 2 303, member 3 307 and member 6 319 requested to participate in the shared marketing message 335 after learning of the desire of member 1 301 to create and send a shared marketing message 335. Member 1 301 then reviews the requests and preferably selects member 2 303, member 3 307 and member 6 319 as participants. Preferably, alternatively member 1 301 may invite a member to participate as a Guest and preferably upon acceptance of the Host invitation by the invited member become a Guest for that particular marketing initiative. As Guests, preferably member 2 303, member 3 307 and member 6 319 each provide a guest marketing message 329 for inclusion in the shared marketing message 335 as shown in deliver guest marketing message 327. As shown, member 4 311 and member 5 315 are not participating in the delivering of the shared marketing message 335, however they preferably may participate in delivery of another shared marketing message 335 at another time. In fact, the members of the marketing introductions network 300 preferably may participate in any combination of Host and Guests for any delivery of a shared marketing message 335.

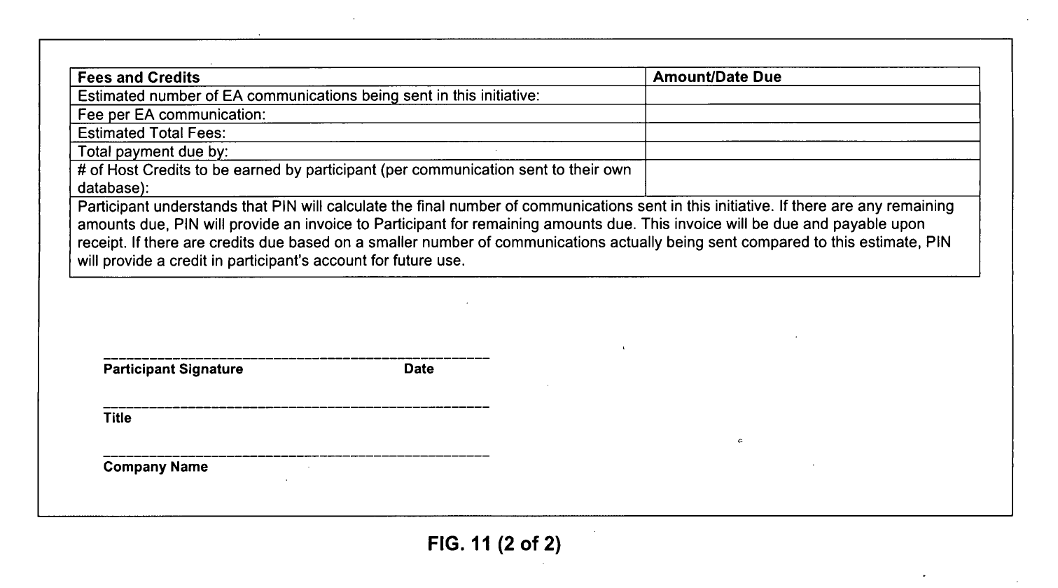

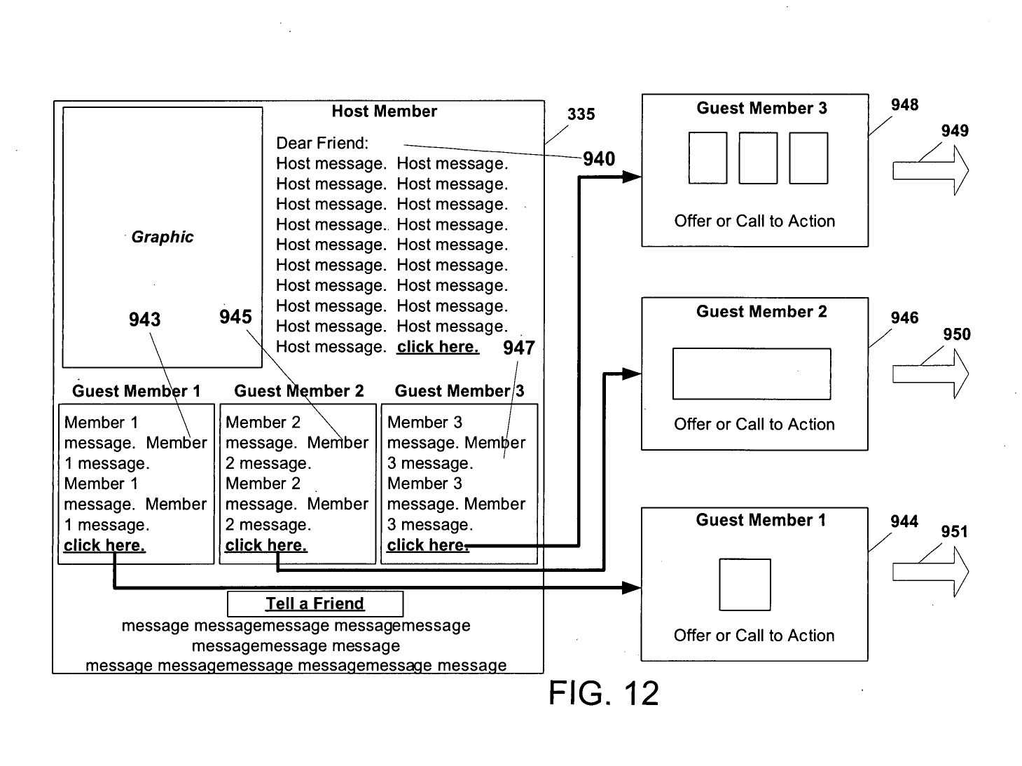

According to a preferred embodiment of the present invention, the network manager 333 will preferably prepare the shared marketing message 335 (see FIG. 12 for an example of a shared marketing message 335) by combining guest marketing message 329 and host marketing message 331. Most preferably, the shared marketing message 335 will be in the form of an email message, but alternately the shared marketing message 335 will be in the form of a direct mail piece, and alternately the shared marketing message 335 will be any other form of communication that permits a message to be delivered to a recipient 337. Preferably, the network manager 333 also reviews the recipient list 330 provided by member 1 301 for duplicates and validity in preparation of delivering the shared marketing message 335. Most preferably, network manager 333 will deliver the shared marketing message 335 to each recipient 337; but alternately the shared marketing message 335 will be delivered by the Host (member 1 301 as illustrated).

Preferably each Guest (member 2 303, member 3 307 and member 6 319) derives the benefit of being “introduced” to the individuals contained in the member 1 customer DB 302. Preferably, organizations of any type may become members of the marketing introductions network 300 (the managed collaborative marketing business set up and operating according to the collaborative marketing system of the present invention). Preferably, organizations may be selected on a predefined criteria for membership, including, but not limited to, primary business location, sales volume, type of product, demographic profile of customers, profit or not-for-profit status, type of political entity, etc.

The marketing introductions network 300 preferably may be organized on a regional basis (such as a metropolitan area), preferably on an industry basis, preferably by a company for its customers, or perhaps on any other basis which may serve the common marketing interests of a group of organizations. Preferably, organizations which provide goods and services in many regions may become members of a marketing introductions network 300 in more than one region. Preferably, a marketing introductions network 300 in one region may permit members from a marketing introductions network 300 in another region to participate in the delivery of shared marketing message 335.

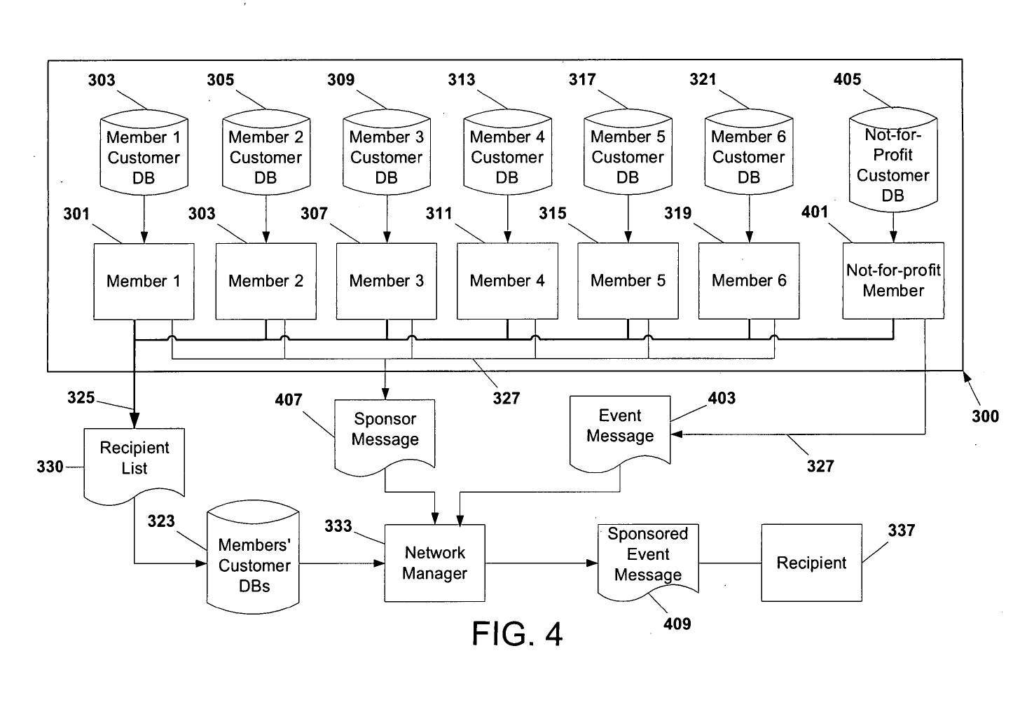

Referring to FIG. 4, a diagrammatical overview for delivery of a fund-raising shared marketing message 409, according to a preferred embodiment of the present invention, illustrates the concept of creation and delivery of a shared fund-raising marketing message to a selected group of recipients 337. Preferably, the recipient list 330 is accumulated from a recipient list 330 contributed by each of the members (member 1 301, member 2 303, member 3 307 member 4 311, member 5 315 and member 6 319) participating in the delivery of fund-raising shared marketing message 409. In addition to the objectives described in relation to FIG. 4, there may be other objectives, for example, an additional objective may include providing a fund-raising opportunity for a particular not-for-profit organization.

Preferably, member 1 301, member 2 303, member 3 307, member 4 311, member 5 315, member 6 319 and not-for-profit member 401 are members of marketing introductions network 300. As shown, member 1 301, member 2 303, member 3 307, member 4 311, member 5 315, member 6 319 and not-for-profit member 401 may all act as the Host for the delivery of shared marketing message 335 by each providing a recipient list 330 from their respective customer databases (member customer DB 1 303, member customer DB 2 305, member customer DB 3 309, member customer DB 4 313, member customer DB 5 317, member customer DB 6 321, not-for-profit customer DB 405) (at least embodying herein entities known to both such at least one first member and such at least one second member). Preferably, the network manager 333 keeps each recipient list 330 confidential and does not permit disclosure to other members even though each recipient list 330 provided will be combined into members' customer DBs 323.

Also, as shown, preferably member 1 301, member 2 303, member 3 307, member 4 311, member 5 315, and member 6 319 act as Sponsors for the delivery of sponsored event message 409. As Sponsors, preferably member 1 301, member 2 303, member 3 307, member 4 311, member 5 315, and member 6 319 each provide a sponsor message 407 for inclusion in the sponsored event message 409, while not-for-profit member 401 preferably provides the event message 403 to the network manager 333 as shown in the step deliver guest marketing message 327. Preferably, any member of the marketing introductions network 300 may participate in delivery of the event message 403, after requesting participation and being selected by the not-for-profit member 401. Preferably, alternatively not-for-profit member 401 may invite a member to participate and preferably, upon acceptance of the invitation by the invited member, the invited member participates in the delivery of the event message 403.

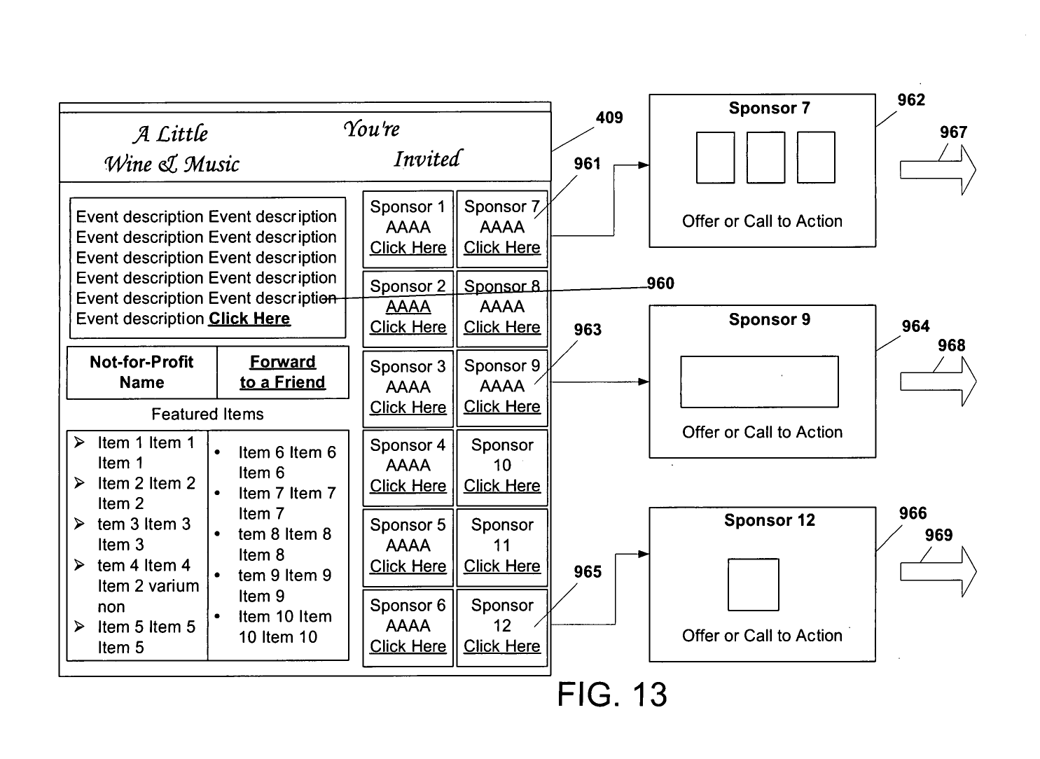

According to a preferred embodiment of the present invention, the network manager 333 will preferably prepare the sponsored event message 409 (see FIG. 13 for an example of a sponsored event message 409) by combining each sponsor message 407 and the event message 403. Preferably, the sponsored event message 409 will be in the form of an email message; and alternately the sponsored event message 409 will be in the form of a direct mail piece; and alternately the sponsored event message 409 will be any other form of communication that permits a message to be delivered to a recipient 337. Preferably, the network manager 333 also reviews the recipient list 330 provided by member customer DB 1 303, member customer DB 2 305, member customer DB 3 309, member customer DB 4 313, member customer DB 5 317, member customer DB 6 321, and not-for-profit customer DB 405 for duplicates and validity in preparation of delivering the sponsored event message 409. Preferably, network manager 333 will deliver the sponsored event message 409 to each recipient 337; but alternately not-for-profit member 401 will deliver the sponsored event message 409 to each recipient 337. As stated, preferably the sponsored event message 409 will be delivered as an email message via the Internet 112; but alternately the sponsored event message 409 will be delivered as a direct mail piece via any chosen delivery service, such as a governmental or private postal service; and alternately the sponsored event message 409 will be delivered via other form of communication that permits a message to be delivered to a recipient 337. As described, preferably each Sponsor (member 1 301, member 2 303, member 3 307, member 4 311, member 5 315, and member 6 319) derives the benefit of being “introduced” to the individuals contained in member customer DB 1 303, member customer DB 2 305, member customer DB 3 309, member customer DB 4 313, member customer DB 5 317, member customer DB 6 321, and not-for-profit customer DB 405. Additionally, not-for-profit member 401 derives the benefit of having its fund-raising messages provided to a much larger group of individuals than would otherwise be possible.

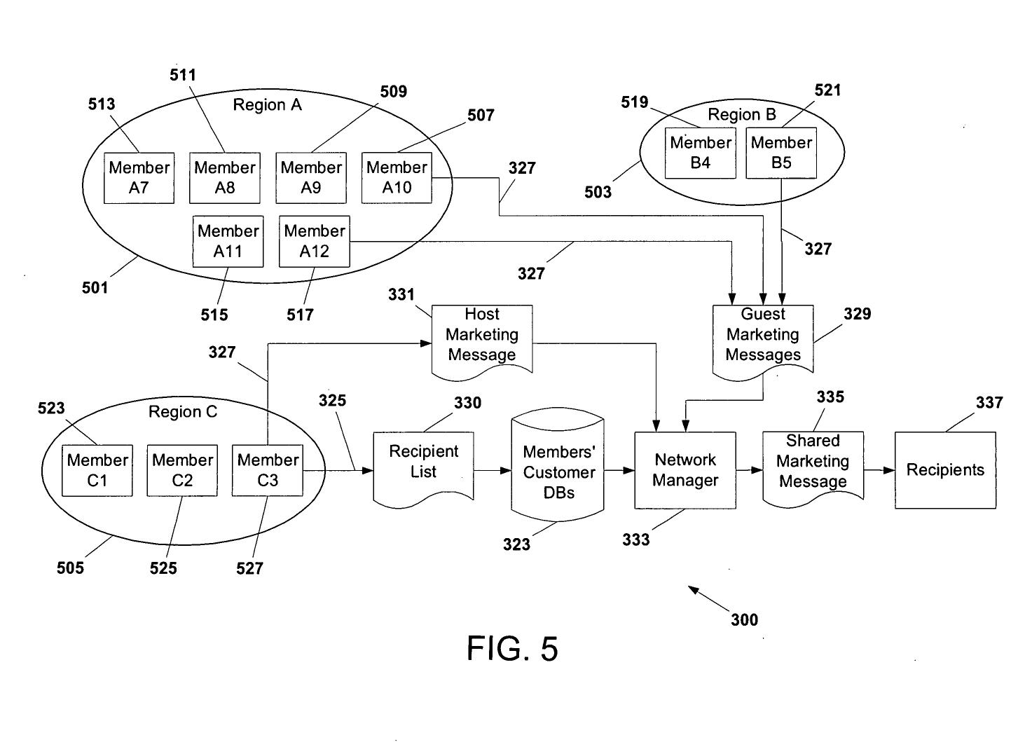

Referring to FIG. 5, a diagrammatical overview for delivery of an inter-regionally oriented shared marketing message 335, according to a preferred embodiment of the present invention, illustrates how members (such as member a10 507, member a12 517, member b5 521, and member c3 527) from more than one marketing introductions network (such as region a marketing introductions network 501, region b marketing introductions network 503, and region c marketing introductions network 505) participate in the creation and delivery of a shared marketing message 335 (at least embodying herein wherein such at least one managed collaborative marketing business is regionally organized). As noted, a marketing introductions network 300 preferably is organized on a regional basis such as a metropolitan area; however, many companies provide goods and services in more than one region and therefore may benefit from participation with members in a marketing introductions network 300 in one or more regions.

As shown, member c3 527 is acting as the Host for the delivery of shared marketing message 335 because the shared marketing message 335 is being sent to individuals on its recipient list 330. Member c3 501 has signified its desire for Guest participation in its shared marketing message 335 by announcing the topic and expected delivery date to all other members of the region a marketing introductions network 501 region b marketing introductions network 503 and region c marketing introductions network 505. Preferably, as Host, member c3 527 provides a recipient list 330 from its customer database to the network manager 333 in database transfer process 325 which is then preferably stored in members' customer DBs 323. Preferably, the recipient list 330 comprises a list of customers of member c3 527; preferably, the recipient list 330 comprises people known to member 1 301; and alternately preferably the list of recipients comprises people not known to member 1 301. Preferably, the network manager 333 keeps recipient list 330 confidential and does not permit disclosure to other members. Additionally, as shown, preferably member c3 527 provides the host marketing message 331 to the network manager 333.

According to a preferred embodiment of the present invention, member a10 507, member a12 517 and member b5 521 act as Guests for the delivery of shared marketing message 335. In the illustration, member a10 507, member a12 517 and member b5 521 requested participation in the shared marketing message 335 after learning of the desire of member c3 527 to create and send a shared marketing message 335. Member c3 527 then reviews the requests and preferably selects member a10 507, member a12 517 and member b5 521 as participants. Preferably, alternatively, member c3 527 may invite a member to participate as a Guest and, preferably, upon acceptance of the Host invitation by the invited member, the invited member will become a Guest for that particular marketing initiative. As Guests, preferably member a10 507, member a12 517 and member b5 521 each provide a guest marketing message 329 for inclusion in the shared marketing message 335 as shown in the step deliver guest marketing message 327. As shown, member a7 513, member a8 511, member a9 509, member a11 515, member c1 523, member c2 525, and member b4 519 are not participating in the delivery of the shared marketing message 335; however they preferably may participate in delivery of another shared marketing message 335 at another time. In fact, the members of the region a marketing introductions network 501, region b marketing introductions network 503, and region c marketing introductions network 505 preferably may participate in any combination of Host and Guests for any delivery of a shared marketing message 335.

According to a preferred embodiment of the present invention, the network manager 333 will preferably prepare the shared marketing message 335 (see FIG. 12 for an example of a shared marketing message 335) by combining each guest marketing message 329 and the host marketing message 331. Preferably, the network manager 333 also reviews the recipient list 330 provided by member 1 301 for duplicates and validity in preparation of delivering the shared marketing message 335. Most preferably, network manager 333 will deliver the shared marketing message 335 to each recipient 337; but, alternately, the shared marketing message 335 will be delivered by the Host (as shown, member c3 527). Most preferably, the shared marketing message 335 will be delivered as an email message via the Internet 112; but alternately, the shared marketing message 335 will be delivered as a direct mail piece via any chosen delivery service, such as a governmental or private postal service; and alternately the shared marketing message 335 will be delivered via other form of communication that permits a message to be delivered to a recipient 337. As described, preferably each Guest (member a10 507, member a12 517 and member b5 521) derives the benefit of being “introduced” to the individuals contained in the customer database of member c3 527.

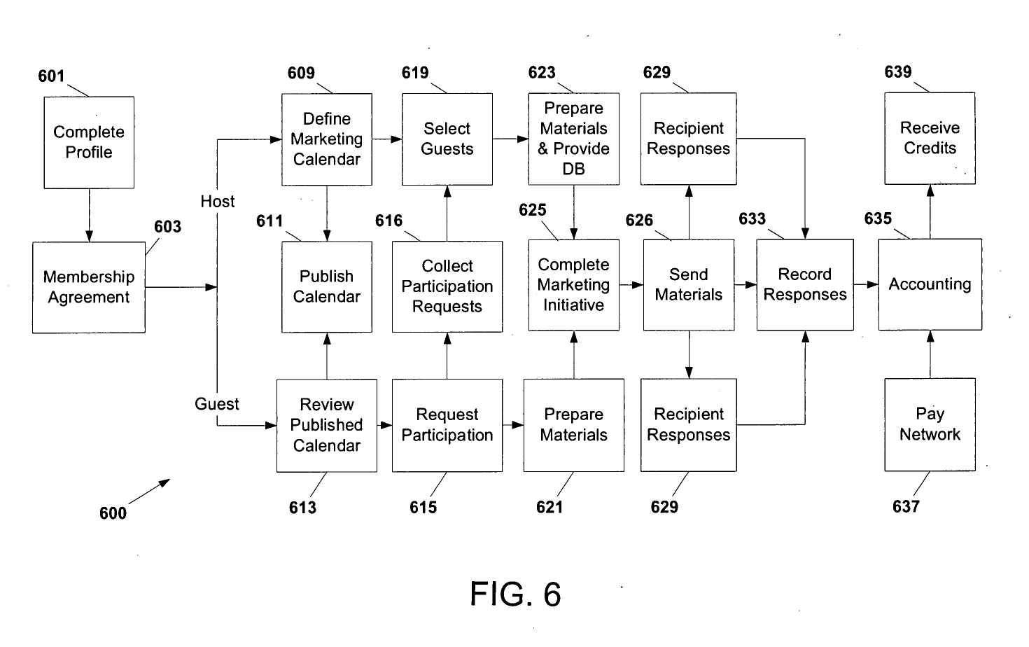

Referring to FIG. 6, a diagrammatical overview of the primary steps for managing marketing introductions networks for delivery of shared marketing messages 335, according to a preferred embodiment of the present invention, illustrates flow of tasks completed by a member acting in the role of a Host (as described in FIG. 3), a member acting in the role as a Guest (as described in FIG. 3), and the network manager 333 to preferably complete the shared marketing process 600. Preferably, the shared marketing process 600 is accomplished primarily through the use of the partner marketing system 800 which is preferably an Internet-based system. Upon reading the teachings of this specification, those with ordinary skill in the art will now understand that, under appropriate circumstances, considering issues such as the number of members and the geographic proximity of the members and the ease of communication between the members and the network manager 333, other arrangements, such as completing the shared marketing process 600 without a software system or by some similar means, may suffice.

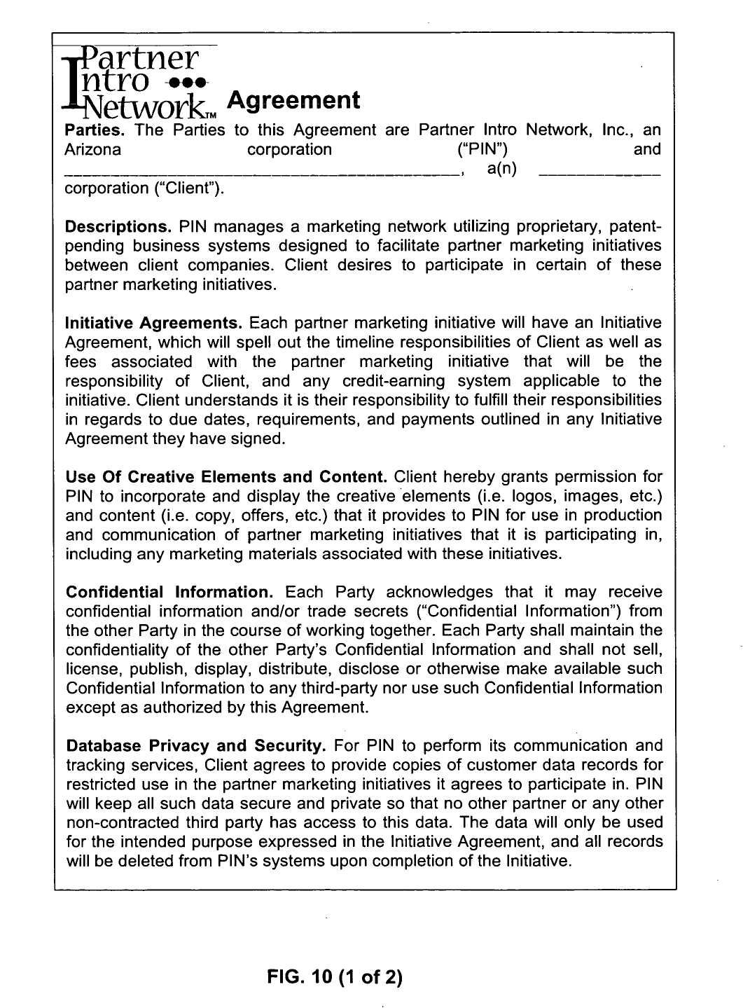

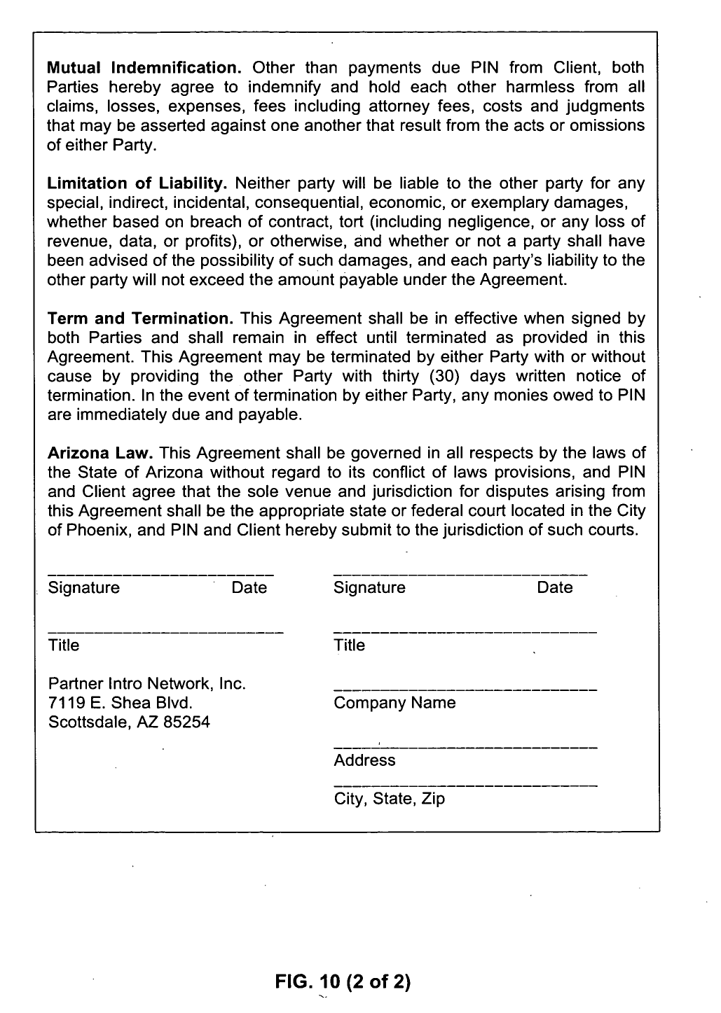

According to a preferred embodiment of the present invention, the shared marketing process 600 begins when companies request to join a marketing introductions network 300 by completing a profile of the organization which comprises information such as: about the organization (commercial company, not-for-profit or some other form); and about the organization's products, the size and demographics of its customer base, selling price of its products and other pertinent market and marketing information as shown in the step Complete Profile 601 (at least embodying herein acquiring at least one profile from at least one plurality of potential members). Next, in step Complete Membership Agreement 603, the potential member must review, complete and sign the membership agreement which describes the general responsibilities of each member and the responsibilities of the network manager 333 (at least embodying herein receiving at least one marketing agreement each from such at least one plurality of potential members). Preferably, the network manager 333 also signs the marketing agreement (at least embodying herein approving agreeing to comply with at least one manager requirement by at least one manager of such at least one managed collaborative marketing business). An example membership agreement is depicted in FIG. 10 (at least embodying herein wherein such at least one manager requirement comprises maintaining all such known entities of such at least one member as confidential; at least embodying herein approving agreeing to comply with at least one member requirement by such at least one potential member; and at least embodying herein wherein such at least one member requirement comprises permitting the use of at least one creative element by such at least one manager, agreement to comply with at least one requirement of at least one initiative agreement). Most preferably, each potential member is not charged a fee to participate as a member; but alternatively each potential member is charged a one-time fee to participate; and alternatively each potential member is charged a recurring periodic fee to participate (at least embodying herein receiving payment of at least one initial registration fee each from such at least one plurality of potential members). Upon acceptance by the network manager 333, each member preferably may choose how to participate in the marketing introductions network 300 (at least embodying herein approving such received marketing agreements, wherein members are determinable). Preferably, each member will participate both as a Host and a Guest in the delivery of one or more shared marketing messages 335 at any one time. Preferably, there is no requirement to participate solely in either a Host or Guest role. Preferably, each member may participate as a Host and a Guest simultaneously.

Preferably, groups of members may consistently work together to collaboratively deliver shared marketing messages 335 to a particular group of individuals or companies, for instance a group may focus on outdoor products, another on business-related products or another on the high-income-demographic individuals, and thus each group may form a “network” within the marketing introductions network 300.

According to a preferred embodiment of the present invention, each member may choose to participate as a Host by completing a marketing calendar consisting of a delivery schedule of one or more shared marketing messages 335 (hereinafter the combination of delivery date and specific shared marketing messages 335 is referred to as marketing initiative), the topic of each and the estimated number of recipients to be reached by the shared marketing message 335 in step Define Marketing calendar 609 and Guest members currently participating in each marketing initiative (at least embodying herein determining at least one first such identity-known member desiring to send at least one shared marketing message, shared with at least one other second identity-unknown member, to at least one plurality of proposed recipients; at least embodying herein receiving at least one marketing calendar from such at least one first member; at least embodying herein wherein such at least one marketing calendar comprises at least one topic of such at least one shared marketing message, and at least one scheduled delivery of such at least one shared marketing message for such at least one topic; and at least embodying herein at least one count of estimated recipients of such at least one shared marketing message; and at least embodying herein at least one count of estimated recipients of such at least one shared marketing message; and at least embodying herein identity of such at least one sharing second member). Preferably, the network manager 333 may assist a member in preparation of a marketing calendar as part of the services provided by the network manager to members (at least embodying herein providing marketing calendar planning assistance to such at least one first member by such at least one manager).

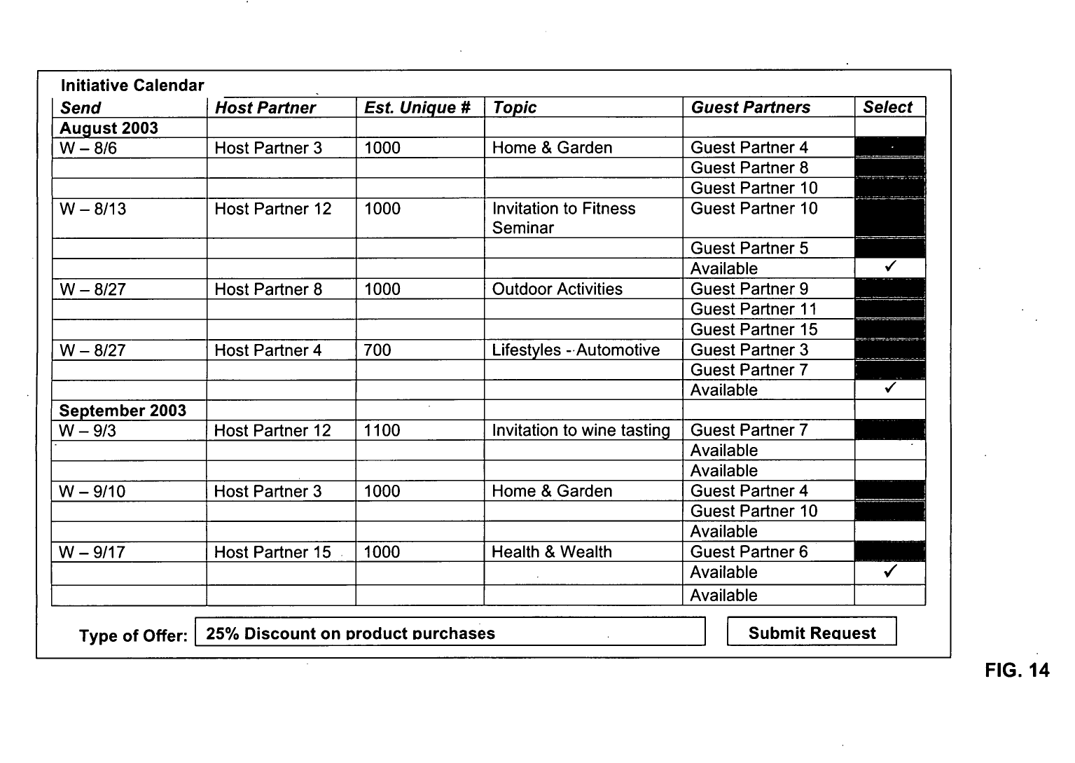

Preferably, once a member has completed the marketing calendar, it is published by the network manager 333 for access by all members of the marketing introductions network 300 as shown in step Publish Calendar 611 (at least embodying herein publishing such at least one marketing calendar of such at least one first member). An example of a published marketing initiative calendar containing members' marketing calendars is shown in FIG. 14. Preferably, each member may add, modify and delete their marketing calendar entries.

Preferably, all members may view the published marketing initiative calendar to determine which marketing initiative is appropriate for their participation as shown in step Review Published Calendar 613. Preferably, the marketing initiative calendar provides sufficient information for a member to choose the marketing initiative in which they wish to participate as a Guest. Preferably, after reviewing the current published marketing initiative calendar a member may request participation in one or more marketing initiatives in step Request Participation 615 (at least embodying herein accepting requests to participate in such at least one scheduled delivery of such at least one shared marketing message for such at least one topic from such at least one second member). The requests are recorded in step Collect Participation Request 616 for review by the Host member.

Preferably, in step Select Guests 617 the requests for participation are then presented to each member acting as a Host for each initiative. The Host member preferably may then select those members which best fit the Host member's objectives for the particular marketing initiative to participate as Guest members (at least embodying herein determining an identity of at least one sharing second member desiring to join such at least one shared marketing message to be sent to such at least one plurality of proposed recipients; and at least embodying herein selecting such at least one requesting second member for participation in such at least one scheduled delivery of such at least one shared marketing message for such at least one topic;). Although members preferably may request participation as Guests for a particular marketing initiative, the Host member preferably may request that specific members participate as Guests for a particular marketing initiative and preferably on acceptance of the invitation the Guest member participates in the same manner as all other Guest member of that particular marketing initiative (at least embodying herein issuing at least one invitation to participate in such at least one scheduled delivery of such at least one shared marketing message for such at least one topic to such at least one second member by such at least one first member; and at least embodying herein accepting such at least one invitation to participate in such at least one scheduled delivery of such at least one shared marketing message for such at least one topic by such at least one second member).

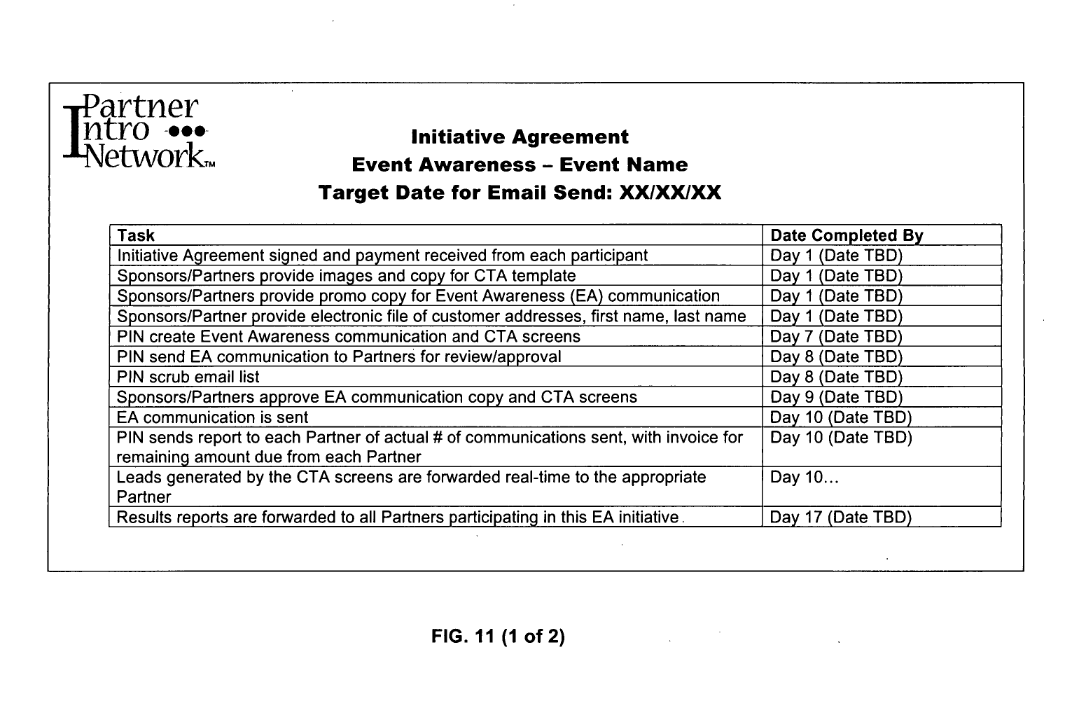

According to a preferred embodiment of the present invention, preferably, in the step Prepare Materials 621, each member selected to be a Guest participant in a particular marketing initiative will sign the Initiative Agreement (See FIG. 11) which provides a list of tasks, Host member, Guest member and network manager 333 responsibilities for completion, and due dates necessary for completion of the particular marketing initiative (at least embodying herein preparing at least one initiative agreement for each such at least one scheduled delivery of such at least one shared marketing message for such at least one topic; and at least embodying herein wherein such at least one initiative agreement comprises at least one schedule of completion dates of at least one manager task, at least one schedule of completion dates of at least one first member task, at least one schedule of completion dates of at least one second member task). Preferably all parties Host member, Guest member and network manager 333 signed the particular initiative agreement signifying their commitment to complete the responsibilities according to the specified completion dates (at least embodying herein agreeing to complete such at least one first member task by such at least one first member; at least embodying herein agreeing to complete such at least one second member task by such at least one second members; and at least embodying herein agreeing to complete such at least one manager task by such at least one manager). For Guest members, the Initiative Agreement provides the basis for calculating the fees to be paid by each Guest member to the network manager 333 for participating in each marketing initiative (at least embodying herein wherein such at least one initiative agreement comprises at least one calculation basis for at least one amount due from such at least one participating second member, and at least one amount due from such at least one participation second member). For Host members, the Initiative Agreement provides the basis for calculating the credits to be received by the Host member from the network manager 333 for providing the recipients list 330 for the marketing initiative (at least embodying herein wherein such at least one initiative agreement comprises at least one benefit amount due to such at least one first member). After signing the Initiative Agreement, each Guest member will prepare the required marketing materials preferably with the assistance of the network manager 333 who preferably provides the design standards and pre-defined marketing materials templates to the Guest member (at least embodying herein providing design assistance for at least one second marketing message by such at least one manager). Most preferably, the Guest member is not charged an additional fee for assistance or templates or other material provided by the network manager 333; but, alternatively, the Guest member may be charged an additional fee for assistance or templates or other material provided by the network manager 333. Preferably, the Guest member is charged an additional fee for custom assistance or custom templates or other custom material provided by the network manager 333. Preferably, the network manager 333 works with each Guest member to ensure a consistent and effective design and content for each Guest member's materials. When the marketing materials are completed they are provided to the network manager 333 (at least embodying herein acquiring at least one second marketing message from such at least one sharing second member).

Similarly, in step Prepare Materials and Provide DB 623 preferably after the Host member signs their copy of the Initiative Agreement, the Host member will prepare the required marketing materials preferably with the assistance of the network manager 333 who preferably provides the design standards and pre-defined marketing materials templates to the Host member (at least embodying herein acquiring at least one first marketing message from such at least one first member). Most preferably, the Host member is not charged an additional fee for assistance or templates or other material provided by the network manager 333; but, alternatively, the Host member may be charged an additional fee for assistance or templates or other material provided by the network manager 333. Preferably, the Guest member is charged an additional fee for custom assistance or custom templates or other custom material provided by the network manager 333. Preferably, the network manager 333 manager works with each Host member to ensure a consistent and effective design and content for each Guest member's materials (at least embodying herein providing design assistance for at least one first marketing message by such at least one manager). When the marketing materials are completed, they are provided to the network manager 333. Preferably, the Host member also provides a recipient list 330 which contains its intended recipients 337 for this particular marketing initiative. Preferably, the recipients 337 list is provided as a complete or partial subset of customers and other potential recipients 337 known to the Host member (at least embodying herein selecting such at least one plurality of recipients of such at least one shared marketing message from such at least one plurality of proposed recipients; at least embodying herein wherein such at least one plurality of recipients are entities known to such at least one first member; and at least embodying herein entities known to such at least one first member). Most preferably, the recipient list 330 is provided in electronic form to the network manager 333; but alternatively, the recipients list 330 may be provided as a hard-copy list to the network manager 333.

Preferably, in the step Complete Marketing Initiative 625, the network manager 333 assembles the marketing materials provided by the Host member and each Guest member into the final shared marketing messages 335 to be delivered to a targeted recipient (at least embodying herein combining such at least one first marketing message and such at least one second marketing message into such at least one shared marketing message; and at least embodying herein wherein the step of combining such at least one first marketing message and such at least one second marketing message into such at least one shared marketing message is completed by such at least one manager). Most preferably, the shared marketing message 335 will be in the form of an email message, but alternately, preferably, the shared marketing message 335 may be in the form of a direct mail piece, and alternately the shared marketing message 335 may be any other form of communication that permits a message to be delivered to a recipient 337.

Preferably, as part of the step Complete Marketing Initiative 625, the network manager 333 will validate and clean up the recipient list 330 provided by the Host member and report any errors encountered and corrections made back to the Host member.

Preferably, when the shared marketing message 335 is complete, the network manager 333 will deliver the shared marketing message 335 to each recipient 337; but alternately the shared marketing message 335 will be delivered by the Host member in step Send Materials 626 (at least embodying herein managing completion of such at least one initiative agreement by such at least one manager; and at least embodying herein wherein the step of sending such at least one shared marketing message to such at least one plurality of recipients is completed by such at least one manager; and at least embodying herein wherein the step of sending such at least one shared marketing message to such at least one plurality of recipients is completed by such at least one first member). Most preferably, the shared marketing message 335 will be in the form of an email message; but alternately the shared marketing message 335 will be in the form of a direct mail piece; and alternately the shared marketing message 335 will be any other form of communication that permits a message to be delivered to a recipient 337 (at least embodying herein sending such at least one shared marketing message to such at least one plurality of recipients). Preferably, the network manager 333 will record a count of the total shared marketing messages 335 sent (at least embodying herein recording the number of such at least one shared marketing messages sent).

Preferably, in step Record Responses 633 the network manager 333 records each response by a targeted recipient 337. Preferably, for email and direct mail messages, this tracking is in the form of receiving and recording web server requests for specific web pages associated with each area on the shared marketing message 335. Preferably, these web server requests may be associated with viewing the shared marketing message 335 or they may be associated with the recipient 337 “clicks on” to view more information about one of the offers contained in the shared marketing message 335 (at least embodying herein recording the number of sent such at least one shared marketing messages responded to by such at least one recipient; at least embodying herein recording the number of sent such at least one first marketing messages responded to by such at least one recipient; and at least embodying herein recording the number of sent such at least one second marketing messages responded to by such at least one recipient). Preferably, the network manager 333 will record and track separately web server requests generated from each offer to permit individualized and confidential reporting to the Host member and each Guest member (at least embodying herein reporting to such at least one first member confidentially the number of such at least one first marketing messages responded to by such at least one recipient; and at least embodying herein reporting to such at least one second member confidentially the number of such at least one second marketing messages responded to by such at least one recipient). See FIG. 16 for an example of the reporting to the Host member and each Guest member for a marketing initiative.

Upon reading the teachings of this specification, those with ordinary skill in the art will now understand that, under appropriate circumstances, considering issues such as method of distribution, tracking costs and the difficulty for tracking responses in non-email message forms other response tracking arrangements, such as, referencing partner specific URLs unique to each marketing initiative in each non-email message and then recording the number of times it is accessed, or by estimating response rates on an agreed basis, or by some similar means, etc., may suffice.

According to a preferred embodiment of the present invention, the network manager 333 will manage the accounting for the charges to Guest Members and the credits to Host members for each marketing initiative in step Accounting 635. The calculations for both the charges and credits are based on the terms defined in the Initiative Agreement. Most preferably, the Guest member fee calculation is based on an agreed rate for each shared marketing messages 335 actually delivered; but, alternatively, the Guest member fee calculation is based on an agreed rate for each recorded response to the Guest member's offer contained in the shared marketing message 335; and, alternatively, the Guest member fee calculation is based on an agreed rate for each recorded viewing of the shared marketing message 335 by the recipient 337; and, alternatively, the Guest member fee calculation is based on an agreed rate for each shared marketing message 335 estimated to be sent; and, alternatively, the Guest member fee calculation is based on any basis agreed to by the Guest member and the network manager 333 (at least embodying herein calculating at least one amount to be paid by such at least one participating second member). In step Pay Network 637 preferably each Guest member pays the network manager 333 the calculated Guest member fee for that particular marketing initiative (at least embodying herein receiving such at least one calculated amount from such at least one participating second member). Preferably, the Host member credit is calculated on the number of recipients 337 provided in the recipient list 330. Preferably, the Host member credit is calculated on the number of shared marketing messages 335 actually sent to recipients 337 provided by the Host member (at least embodying herein calculating at least one benefit amount attributable to such at least one first member).

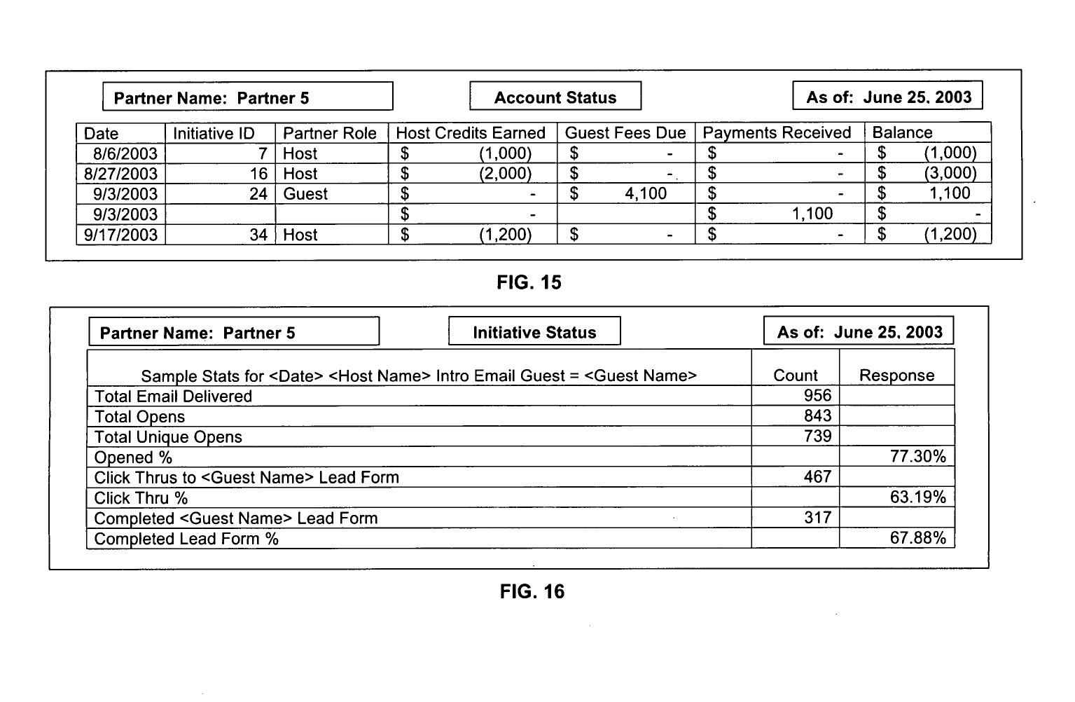

Preferably, in step Receive Credits 639, each Host member receives the agreed amount as a credit to the member's account from the network manager 333, as illustrated in FIG. 15. Preferably, credits received from a member's participation in a marketing initiative as a Host may be used to offset any future charges for the member's participation as a Guest in a marketing initiative as illustrated in FIG. 15. Preferably, the sum of the amounts charged to each Guest member for a particular event awareness initiative will be greater than the credits provided to the Host member, thus providing an operating profit to the network manager 333 (at least embodying herein retaining as operating profit at least one portion of such at least one calculated amount). Preferably, each Guest member remits the agreed amount to the network manager 333, who records the payment and updates the members account status. See FIG. 15 for an example of a member's account status report.

Upon reading the teachings of this specification, those with ordinary skill in the art will now understand that, under appropriate circumstances, considering issues such as convenience demanded by a Host member, other payment arrangements, such as, payment of agreed amounts to the Host member rather than issuance account credits for participation in a particular marketing initiative or some similar means, etc., may suffice.

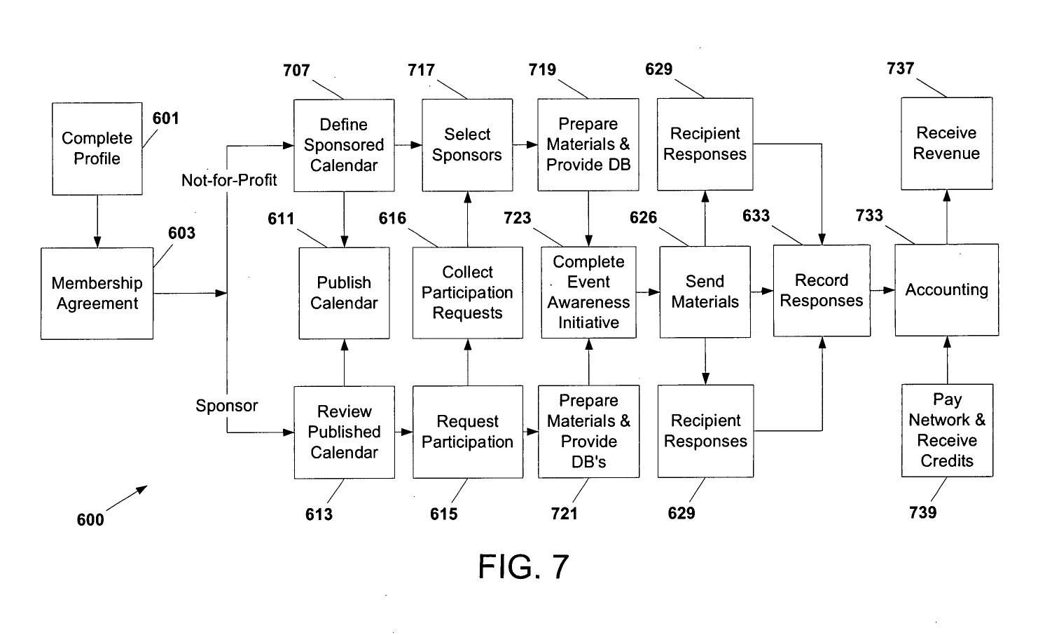

Referring to FIG. 7, a diagrammatical overview of the primary steps for managing marketing introductions networks for delivery of fund-raising shared marketing messages 409, according to a preferred embodiment of the present invention, illustrates flow of tasks completed by a member acting in the role of a Not-For-Profit (as described in FIG. 5), a member acting in the role as a Sponsor (as described in FIG. 5), and the network manager 333 to preferably complete the shared marketing process 600. Preferably, the shared marketing process 600 is accomplished primarily through the use of the partner marketing system 800 which is preferably an Internet-based system. Upon reading the teachings of this specification, those with ordinary skill in the art will now understand that, under appropriate circumstances, considering issues such as the number of members, the geographic proximity of the members, the ease of communication between the members and the network manager 333, etc., other arrangements, such as, completing the shared marketing process 600 without a software system or by some similar means, etc., may suffice.

According to a preferred embodiment of the present invention, the shared marketing process 600 begins when companies preferably request to join a marketing introductions network 300 by completing a profile of the organization which comprises information about the organization (commercial company, not-for-profit or some other form), the organization's products, the size and demographics of its customer base, selling price of its products and other pertinent market and marketing information as shown in the step Complete Profile 601. Next, in step Complete Membership Agreement 603, the potential member must review and complete the membership agreement which describes the general responsibilities of each member and the responsibilities of the network manager 333. An example membership agreement is depicted in FIG. 10. Preferably, each potential member is not charged a fee to participate as a member; alternately, preferably each potential member may be charged a one-time fee to participate; and alternately, each potential member may be charged a recurring periodic fee to participate. Upon acceptance by the network manager 333, each member preferably may choose how to participate in the marketing introductions network 300. Preferably, each not-for-profit member will participate both as a Host and a Guest in the delivery of one or more sponsored event messages 409 at any one time. Preferably, there is no requirement to participate solely in either a Host or guest role. Preferably, each member may participate as a Host and a Guest simultaneously.

Preferably, groups of members may consistently work together to collaboratively deliver sponsored event messages 409 to a particular group of individuals or companies, for instance, a group may focus on outdoor products, another on business-related products or another on the high-income-demographic individuals; and each group may thus form a “network” within the marketing introductions network 300.

According to a preferred embodiment of the present invention, each member may choose to participate as a Not-For-Profit member by completing a marketing calendar consisting of a delivery schedule of one or more sponsored event messages 409 (hereinafter the combination of delivery date and specific sponsored event message 409 is referred to as event awareness initiative), the topic of each and the estimated number of recipients to be reached by the sponsored event message 409 in step Define Sponsored Campaign 707.

Preferably, once a Not-For Profit member has completed the sponsored campaign, it is published by the network manager 333 for access by all members of the marketing introductions network 300 as shown in step Publish Calendar 611. An example of a published marketing initiative calendar containing members' sponsored campaigns is shown in FIG. 14. Preferably, each member may add, modify and delete their marketing calendar entries.

Preferably, all members may view the published marketing initiative calendar to determine which event awareness initiative is appropriate for their participation as shown in step Review Published Calendar 613. Preferably, the marketing initiative calendar provides sufficient information for a member to choose the event awareness initiative in which they wish to participate as a Sponsor. Preferably, after reviewing the current published marketing initiative calendar, a member may request participation in one or more event awareness initiatives in step Request Participation 615. The requests are recorded in step Collect Participation Requests 616 for review by the Not-For-Profit member.

Preferably, in step Select Sponsors 717, the requests for participation are then presented to each member acting as a Not-For-Profit for each initiative. The Not-For-Profit member preferably may then select those members which best fit the Not-For-Profit member's objectives for the particular event awareness initiative. Although members preferably may request participation as Sponsors for a particular event awareness initiative, the Not-For-Profit member preferably may request that specific members participate as Sponsors for a particular event awareness initiative.

According to a preferred embodiment of the present invention, preferably in the step Prepare Materials and Provide DB's 721, each member selected to be a Sponsor participant in a particular event awareness initiative will sign the Initiative Agreement (See FIG. 11) which provides a list of tasks, responsibilities for completion, and due dates necessary for completion of the particular event awareness initiative. For Sponsor members, the Initiative Agreement provides the basis for calculating the fees to be paid by each Sponsor member to the network manager 333 for participating in each event awareness initiative. Also, for Sponsor members, the Initiative Agreement also provides the basis for calculating the credits to be received by the Sponsor member from the network manager 333 for providing the recipients list 330 for the event awareness initiative. After signing the Initiative Agreement, each Sponsor member will prepare the required marketing materials, preferably with the assistance of the network manager 333, who preferably provides the design standards and pre-defined marketing materials templates to the Sponsor member. Preferably, the Sponsor member is not charged an additional fee for assistance or templates or other material provided by the network manager 333; alternately, preferably, the Sponsor member may be charged an additional fee for assistance or templates or other material provided by the network manager 333; and, alternately, the Sponsor member may be charged an additional fee for custom assistance or custom templates or other custom material provided by the network manager 333. Preferably, the network manager 333 manager works with each Sponsor member to ensure a consistent and effective design and content for each Sponsor member's materials. When the marketing materials are completed they are provided to the network manager 333. Preferably, the Sponsor member also provides a recipient list 330 which contains its intended recipients 337 for this particular event awareness initiative. Preferably the recipients 337 list is provided as a complete or partial subset of customers and other potential recipients 337 known to the Sponsor member (at least embodying herein entities known to such at least one second member). Preferably the recipient list 330 is provided in electronic form to the network manager 333, preferably the recipients list 330 is provide as a hard-copy list to the network manager 333.

Similarly, in step Prepare Materials and Provide DB 719 preferably after the Not-For-Profit member signs their copy of the Initiative Agreement and then Not-For-Profit member prepares the required marketing materials preferably with the assistance of the network manager 333 who preferably provides the design standards and pre-defined marketing materials templates to the Not-For-Profit member. Preferably the Not-For-Profit member is not charged an additional fee for assistance or templates or other material provided by the network manager 333, preferably the Not-For-Profit member is charged an additional fee for assistance or templates or other material provided by the network manager 333, preferably the Sponsor member is charged an additional fee for custom assistance or custom templates or other custom material provided by the network manager 333. Preferably, the network manager 333 manager works with each Not-For-Profit member to ensure a consistent and effective design and content for each Sponsor member's materials. When the marketing materials are completed they are provided to the network manager 333. Preferably, the Not-For-Profit member also provides a recipient list 330 which contains its intended recipients 337 for this particular event awareness initiative. Preferably the recipients 337 list is provided as a complete or partial subset of customers and other potential recipients 337 known to the Not-for-Profit member. Preferably the recipient list 330 is provided in electronic form to the network manager 333, preferably the recipients list 330 is provide as a hard-copy list to the network manager 333.

Preferably, in the step Complete Event Awareness Initiative 723 the network manager 333 assembles the marketing materials provided by the Not-For-Profit member and each Sponsor member into the final sponsored event message 409 to be delivered to a targeted recipient. Most preferably, the sponsored event message 409 will be in the form of an email message, but alternately the sponsored event message 409 will be in the form of a direct mail piece, and alternately the sponsored event message 409 will be any other form of communication that permits a message to be delivered to a recipient 337.

Preferably, as part of the step Complete Event Awareness Initiative 723, the network manager 333 will validate and clean up the recipient list 330 provided by the Not-For-Profit member and each Sponsor member and report any errors encountered and corrections made back to the Not-For-Profit member and each Sponsor member. Each recipient list 330 provided, and related reporting, is preferably kept secure and confidential to the providing member.

Preferably, when the sponsored event message 409 is complete, the network manager 333 will manage its delivery to the targeted recipients 337; but, alternately, the Not-For-Profit member may manage its delivery to the targeted recipients 337 in step Send Materials 626. Most preferably, the sponsored event message 409 will be in the form of an email message; but alternately, preferably, the sponsored event message 409 will be in the form of a direct mail piece; and, alternately, the sponsored event message 409 will be any other form of communication that permits a message to be delivered to a recipient 337. Preferably, the network manager 333 will record a count of the total sponsored event messages 409 sent.

Preferably, in step Record Responses 633, the network manager 333 records each response by a targeted recipient 337. Preferably, for email messages this tracking is in the form of receiving and recording web server requests for specific web pages associated with each area on the sponsored event message 409. Preferably, these web server requests may be associated with viewing the sponsored event message 409 or they may be associated with what the recipient 337 “clicks on” to view more information about one of the offers contained in the sponsored event message 409. Preferably, the network manager 333 will record and track separately web server requests generated from each offer to permit individualized and confidential reporting to the Not-For-Profit member and each Sponsor member. See FIG. 16 for an example of the reporting to the Not-For-Profit member and each Sponsor member for a event awareness initiative. Upon reading the teachings of this specification, those with ordinary skill in the art will now understand that, under appropriate circumstances, considering issues such as method of distribution, tracking costs and the difficulty for tracking responses in non-email message forms, other response tracking arrangements, such as, referencing partner specific URL's unique to each marketing initiative in each non-email message and then recording the number of times is accessed, or by estimating response rates on an agreed basis, or by some similar means, etc, may suffice.

According to a preferred embodiment of the present invention, the network manager 333 will manage the accounting for the charges to Sponsor Members and the credits to Not-For-Profit members for each event awareness initiative in step Accounting 733. The calculations for both the Not-For-Profit member and Sponsor members are based on the terms defined in the Initiative Agreement. Preferably, the Sponsor member fee calculation is based on an agreed rate for each sponsored event message 409 actually delivered; preferably the Sponsor member fee calculation may be based on an agreed rate for each recorded response to the Sponsor member's offer contained in the sponsored event message 409; and preferably, the Sponsor member fee calculation is based on an agreed rate for each recorded viewing of the sponsored event message 409 by the recipient 337; again, alternately, preferably, the Sponsor member fee calculation is based on an agreed rate for each sponsored event message 409 estimated to be sent; and alternately, the Sponsor member fee calculation is based on any basis agreed to be the Sponsor member and the network manager 333. Preferably, the Sponsor member credit is calculated on the number of recipients 337 provided in the recipient list 330. Preferably the Sponsor member credit is calculated on the number of sponsored event messages 409 actually sent to recipients 337 provided by the Sponsor member.

Preferably, in step Pay Network & Receive Credits 739, each Not-For-Profit member receives the agreed amount as a credit to the member's account from the network manager 333, as illustrated in FIG. 15. Preferably, credits received from a member's participation in an event awareness initiative as a Not-For-Profit may be used to offset any future charges for the member's participation as a Sponsor in another event awareness initiative as illustrated in FIG. 15. Preferably, the sum of the amounts charged to each Sponsor member for a particular event awareness initiative is greater than the credits provided the Not-For-Profit member of that particular event awareness initiative, thus preferably providing an operating profit to the network manager 333. Preferably, each Sponsor member remits the difference in the fee charged and the credit earned to the network manager 333 who records the payment and updates the member's account status. See FIG. 15 for an example of a member's account status report.

Preferably, in step Receive Revenue 737, a portion of the profit received by the network manager 333 is paid to the Not-For-Profit member as revenue to the Not-For-Profit member; but a portion of the profit received by the network manager 333 may be optionally paid to the Not-For-Profit member as revenue to the Not-For-Profit member. Upon reading the teachings of this specification, those with ordinary skill in the art will now understand that, under appropriate circumstances, considering issues such as convenience demanded by a Not-For-Profit member, etc., other payment arrangements, such as, payment of agreed amounts to the Not-For-Profit member rather than issuance of account credits for participation in a particular event awareness initiative or some similar means, etc., may suffice.

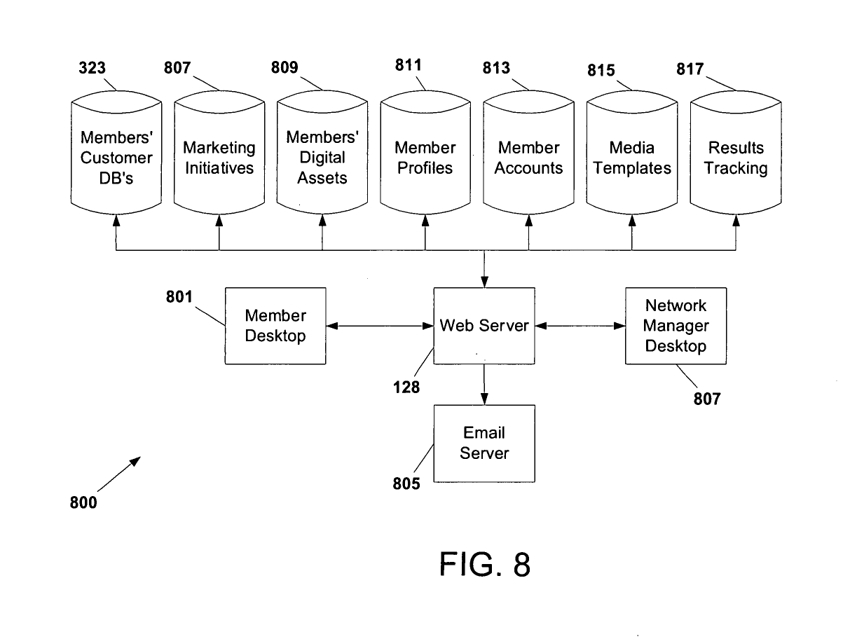

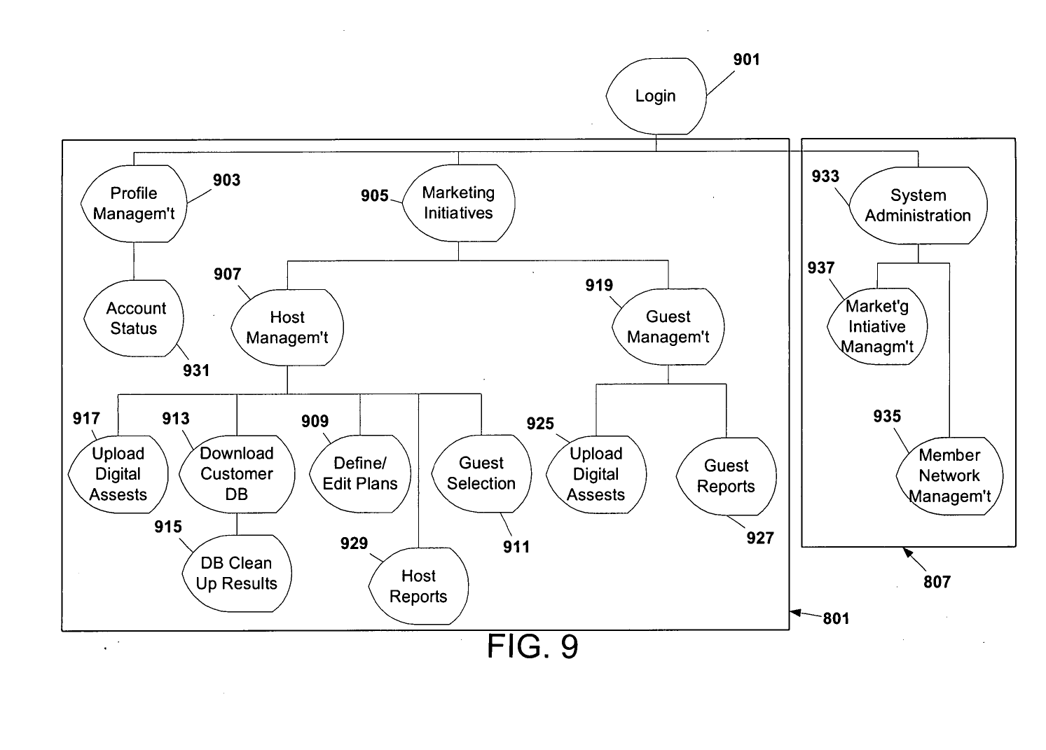

Referring to FIG. 8, a summary schematic of the primary functional components of the partner marketing system 800, according to the preferred embodiment of a present invention, illustrates the preferred implementation of the system in a computer-based environment. Preferably, the partner marketing system 800 operates in an Internet-based environment; preferably, alternately, the partner marketing system 800 operates in a mixed local area network and Internet-based environment. As shown, preferably the web server 128 provides the central process environment of the system housing all the necessary functions to complete the steps described in reference to FIG. 6 and FIG. 7. To accomplish these functions, the partner marketing system 800 retains a variety of information in various databases. In particular, the Members Customer DB's 323 contains the download recipient lists 330 from each member. Each member's recipient list 330 is preferably maintained confidential to that member, thus providing the opportunity to share the recipient list 330 as a marketing tool, while prevent poaching of customers by other members. Preferably, database Marketing Initiatives 807 contains the marketing calendars, the related marketing initiatives and Initiative Agreements permitting the network manager 333 to manage and report the marketing introductions network 300 activities and members of the marketing introductions network 300 to participate as Host, Guest, Not-For-Profit or Sponsor in marketing initiatives and event awareness initiatives of their choice. Preferably, the database Member's Digital Assets 809 contains all images, text and other marketing materials used in the completion of either marketing initiatives or event awareness initiatives. These materials preferably are kept confidential to each member. Preferably, the database member profiles 811 contains information about each member which permits other members to participate in the most appropriate marketing initiatives and event awareness initiatives and to form “networks” within the marketing introductions network 300. Preferably, each member's public portions of their profile are available for review by other members. Preferably, the database Member Accounts retains a detailed historical record of charges and all credits during each member's tenure (at least embodying herein computer storage means for storing such at least one calculated amount from such at least one participating second member). Preferably this database is used to complete the necessary account status reports. Preferably, the database Media Templates 815 contains all the pre-formatted materials used to assist members in the preparation of shared marketing messages 335 as Host, Guest, or sponsored event messages 409 as Not-For-Profit or Sponsor. Preferably, the database Results Tracking 817 retains all data for each marketing initiative relating to volumes of materials sent, recipient responses, etc. Preferably, Results Tracking 817 is used for status reporting and for calculating fees and credits for members. Preferably, the member Desktop 801 provides the primary access point for members for participation in the marketing introductions network 300. See FIG. 9 for an illustration of the preferred functions provided by the Member Desktop 801. Preferably, the Network Manager Desktop 807 provides all the functions required for the network manager 333 to manage members, marketing initiatives, event awareness initiatives, and all other functions described in relation to FIG. 6 and FIG. 7. Preferably, the partner marketing system 800 will have a direct interface to an Email Server 805 for delivery of the shared marketing messages 335 and sponsored event messages 409 as well as general member communications.

Referring to FIG. 9, a diagrammatical overview of the primary member desktop functions of the partner marketing software system 800, according to a preferred embodiment of the present invention, illustrates how members of the marketing introductions network 300 will use the partner marketing system 800. Preferably, on reaching the marketing introductions network 300 web site, each member will be presented login 901 and required to login using an id and password assigned exclusively to each member. Potential members will be permitted to go directly to a special version of the profile management 903. On completion of the member agreement and acceptance by the network manager 333, new members will be issued an id and password. As a member, preferably, profile management may be used to update the member's profile and access the display for account status 931 (at least embodying herein computer interface means for acquiring at least one profile from at least one plurality of potential members). See FIG. 15 for an example of the account status display.

Preferably, after logging in, each member may access Marketing Initiatives 905 for the purpose of managing marketing initiatives or event awareness initiatives in which the member may be participating. For example, selecting Host Management 907 preferably permits the member to use Upload Digital Assets 917 to place logos, marketing copy, images or other digital materials in the Member's Digital Assets database (at least embodying herein computer interface means for permitting at least one first such identity-known member to send at least one shared marketing message, shared with at least one other second member, to at least one plurality of proposed recipients; and at least embodying herein computer processor means for acquiring at least one first marketing message from such at least one first member). Additionally, the member may use Download Customer Database 913 to download a recipient list to Member's Customer DB's 323 for use in a marketing initiative or event awareness initiative (at least embodying wherein such at least one plurality of recipients are entities known to such at least one first member; and at least embodying herein wherein such at least one plurality of recipients comprises entities known to such at least one first member, entities known to such at least one second member, entities known to both such at least one first member and such at least one second member). The member may use DB Clean Up Results 915 to view the results of name and address clean up work done by the network manager 333. Preferably, the member may use Define/Edit Plans 909 to create and edit marketing calendars and marketing initiatives or event awareness initiatives (at least embodying herein computer interface means for receiving at least one marketing calendar from such at least one first member). See FIG. 14 for an example marketing calendar (at least embodying herein wherein such at least one marketing calendar comprises at least one topic of such at least one shared marketing message and at least one scheduled delivery of such at least one shared marketing message for such at least one topic; and at least embodying herein wherein such at least one marketing calendar further comprises at least one count of estimated recipients of such at least one shared marketing message, and identity of such at least one sharing second member). Preferably, the member may use Guest Selection 911 to review members who have requested participation as a Guest member in a marketing initiative for which the member is the Host member (at least embodying herein computer interface means for selecting such at least one requesting second member for participation in such at least one scheduled delivery of such at least one shared marketing message for such at least one topic). Additionally, preferably, Guest Selection 911 is used by Not-For-Profit members to select Sponsor members for event awareness initiatives. Additionally, Guest Selection 911 may be used to initiate a request to a member to join a particular marketing initiative or event awareness initiative (at least embodying herein computer interface means for issuing at least one invitation to participate in such at least one scheduled delivery of such at least one shared marketing message for such at least one topic to such at least one second member by such at least one first member). Preferably, Host Reports 929 permits the member to review the status of each marketing initiative or event awareness initiative in terms of materials sent and recipient response rates (at least embodying herein computer processor means for recording the number of such at least one shared marketing messages sent; at least embodying herein computer processor means for recording the number of sent such at least one shared marketing messages responded to by such at least one recipient; at least embodying herein computer processor means for recording the number of sent such at least one first marketing messages responded to by such at least one recipient; and at least embodying herein computer processing means for reporting to such at least one first member confidentially the number of such at least one first marketing messages responded to by such at least one recipient). See FIG. 16 for an example marketing initiative status report.

Preferably, the member may go to Guest Management 919 to view upcoming marketing initiatives and event awareness initiatives (at least embodying herein computer processing means for publishing such at least one marketing calendar of such at least one first member). An example of a display of upcoming marketing initiatives and event awareness initiatives is shown in FIG. 14. As shown, the member preferably may submit a request for participation for any open marketing initiative or event awareness initiative (at least embodying herein computer interface means for permitting at least one sharing second member desiring to join such at least one shared marketing message to be sent to such at least one plurality of proposed recipients; and at least embodying herein computer interface means for accepting requests to participate in such at least one scheduled delivery of such at least one shared marketing message for such at least one topic from such at least one second member). Preferably, the member may accept or decline an invitation from a Host member to participate in a particular marketing initiative or may accept or decline an invitation from a Not-For-Profit member (at least embodying herein computer interface means for accepting such at least one invitation to participate in such at least one scheduled delivery of such at least one shared marketing message for such at least one topic by such at least one second member). Preferably, accessing Upload Digital Assets 925 provides the member the ability to upload logos, images or marketing copy to the member's portion of the database of Members' Digital Assets 809 for use in one or more marketing initiatives or event awareness initiatives (at least embodying herein computer processor means for acquiring at least one second marketing message from such at least one sharing second member). Preferably, accessing Guest Reports 927 permits the member to view status of each marketing initiative or event awareness initiative in terms of materials sent and recipient response rates relative to the member's offering included in each marketing initiative or event awareness initiative (at least embodying herein computer processor means for recording the number of sent such at least one second marketing messages responded to by such at least one recipient; and at least embodying herein computer processing means for reporting to such at least one second member confidentially the number of such at least one second marketing messages responded to by such at least one recipient). See FIG. 16 for an example marketing initiative status report.

Preferably, after logging in to the partner marketing system 800, the network manager 333 may use System Administration 933 to add, delete or change any of the system parameters required to maintain the system. Preferably, the network manager 333 uses Marketing Initiative Management 937 to manage each marketing initiative or event awareness initiative including completing the shared marketing messages 335, completing sponsored event messages 409, recipient list 330 clean-up, sending the shared marketing messages 335 or sponsored event messages 409 to the recipient lists, and managing returned items (at least embodying herein computer processor means for combining such at least one first marketing message and such at least one second marketing message into such at least one shared marketing message; at least embodying herein computer processor means for selecting such at least one plurality of recipients of such at least one shared marketing message from such at least one plurality of proposed recipients; at least embodying herein computer communication means for sending such at least one shared marketing message to such at least one plurality of recipients; and at least embodying herein wherein the computer processor means for combining such at least one first marketing message and such at least one second marketing message into such at least one shared marketing message is controlled by such at least one manager; and at least embodying herein wherein the computer communication means for sending such at least one shared marketing message to such at least one plurality of recipients is controlled by such at least one manager). Preferably, all other functions associated with managing marketing initiatives and event awareness initiatives are preferably available to the network manager from here. Preferably, the network manager 333 uses Member Network Management 935 to manage all aspects of the database of members including the approval of new members, calculating fees and credits, managing accounts and other related functions necessary for the operation of marketing introductions network 300 (at least embodying herein computer processor means for calculating at least one amount to be paid by such at least one participating second member; and at least embodying herein computer processor means for calculating at least one benefit amount attributable to such at least one first member).

Referring to FIG. 12, a diagrammatical view of a shared marketing message 335, according to a preferred embodiment of the present invention, illustrates the preferred form and primary components used to elicit responses from targeted recipients 337 in a marketing initiative. As illustrated, the host message 940 preferably provides the primary message and a specific URL reference to Host member's web site or other Internet-based location (shown as “click here”). Guest 1 message 943, guest message 2 945 and guest message 3 947 preferably are provided by the guest members selected to participate in this marketing initiative. Each of these message areas preferably contains a brief message and a specific and marketing-initiative unique URL reference to a call-to-action web page: guest 1 call-to-action 944, guest 2 call-to-action 946, and guest 3 call-to-action 948 respectively (shown as “click here”). Each of these call-to-action web pages preferably is created by the network manager 333 from digital information provided by the Guest members and placed on the web server 124 of the marketing introductions network 300. This arrangement preferably permits explicit tracking of responses by recipients 337 to each message contained in the shared marketing message 335. Once a recipient 337 arrives at one of the call-to-action pages, they preferably access the Guest member's own web site and become a customer of the Guest member, as depicted by arrow 949, arrow 950 and arrow 951. Most preferably, the shared marketing message 335 will be in the form of an email message; but alternately the shared marketing message 335 may be in the form of a direct mail piece.

Referring to FIG. 13, a diagrammatical view of a sponsored event message 409, according to a preferred embodiment of the present invention, illustrates the preferred form and primary components used to elicit responses from targeted recipients 337 in an event awareness initiative. As illustrated, the Not-For-Profit message 960 preferably provides the primary event information, a call to action and a specific URL reference to Not-For-Profit member's web site or other Internet-based location (preferably having the words “click here” or similar). Sponsor 7 message 991, Sponsor 9 message 963 and guest 12 message 965 (exemplary of Sponsor 1 message through Sponsor 12 message) preferably are provided by the Sponsor members selected to participate in this event awareness initiative. Each of these message areas preferably contains a brief message and a specific and event-awareness-initiative unique URL reference to a call-to-action web page: sponsor 7 call-to-action 962, sponsor 9 call-to-action 964, and sponsor 12 call-to-action 966 respectively (shown here as “click here”). Each of these call-to-action web pages preferably is created by the network manager 333 from digital information provided by the Sponsor members and placed on the web server 124 of the marketing introductions network 300. This arrangement preferably permits explicit tracking of responses by recipients 337 to each message contained in the sponsored event message 409. Once a recipient 337 arrives at one of the call-to-action pages they preferably access the Guest member's own web site and become a customer of the Guest member, as depicted by arrow 967, arrow 968 and arrow 969. Most preferably, the sponsored event message 409 will be in the form of an email message; but alternately the shared marketing message 335 will be in the form of a direct mail piece.

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

1) A collaborative marketing management system, relating to at least one managed collaborative marketing business, comprising the steps of:
a) acquiring at least one profile from at least one plurality of potential members;
b) receiving at least one marketing agreement each from such at least one plurality of potential members;
c) approving such received marketing agreements, wherein members are determinable;
d) determining at least one first such identity-known member desiring to send at least one shared marketing message, shared with at least one other second identity-unknown member, to at least one plurality of proposed recipients; and
e) determining an identity of at least one sharing second member desiring to join such at least one shared marketing message to be sent to such at least one plurality of proposed recipients.

2) The collaborative marketing management system according to claim 1 further comprising the steps of:
a) receiving at least one marketing calendar from such at least one first member;
b) wherein such at least one marketing calendar comprises:
i) at least one topic of such at least one shared marketing message, and
ii) at least one scheduled delivery of such at least one shared marketing message for such at least one topic;
c) acquiring at least one first marketing message from such at least one first member;
d) acquiring at least one second marketing message from such at least one sharing second member;
e) combining such at least one first marketing message and such at least one second marketing message into such at least one shared marketing message;
f) selecting such at least one plurality of recipients of such at least one shared marketing message from such at least one plurality of proposed recipients; and
g) sending such at least one shared marketing message to such at least one plurality of recipients.

3) The collaborative marketing management system according to claim 2 further comprising the steps of:
a) calculating at least one amount to be paid by such at least one participating second member;
b) calculating at least one benefit amount attributable to such at least one first member; and
c) receiving such at least one calculated amount from such at least one participating second member.

4) The collaborative marketing management system according to claim 3 further comprising the steps of:
a) retaining as operating profit at least one portion of such at least one calculated amount.

5) The collaborative marketing management system according to claim 2 further comprising the steps of:
a) recording the number of such at least one shared marketing messages sent;
b) recording the number of sent such at least one shared marketing messages responded to by such at least one recipient;
c) recording the number of sent such at least one first marketing messages responded to by such at least one recipient;
d) recording the number of sent such at least one second marketing messages responded to by such at least one recipient;
e) reporting to such at least one first member confidentially the number of such at least one first marketing messages responded to by such at least one recipient; and
f) reporting to such at least one second member confidentially the number of such at least one second marketing messages responded to by such at least one recipient.

6) The collaborative marketing management system according to claim 2 wherein such at least one plurality of recipients are entities known to such at least one first member.

7) The collaborative marketing management system according to claim 2 wherein such at least one plurality of recipients consist essentially of:
a) entities known to such at least one first member; or
b) entities known to such at least one second member; or
c) entities known to both such at least one first member and such at least one second member.

8) The collaborative marketing management system according to claim 2 wherein such at least one marketing calendar further comprises:
a) at least one count of estimated recipients of such at least one shared marketing message; and
b) identity of such at least one sharing second member.

9) The collaborative marketing management system according to claim 2 wherein the step of determining at least one second member desiring to join such at least one shared marketing message to be sent to such at least one plurality of proposed recipients comprises the steps of:
a) publishing such at least one marketing calendar of such at least one first member;
b) accepting requests to participate in such at least one scheduled delivery of such at least one shared marketing message for such at least one topic from such at least one second member;
c) selecting such at least one requesting second member for participation in such at least one scheduled delivery of such at least one shared marketing message for such at least one topic;
d) issuing at least one invitation to participate in such at least one scheduled delivery of such at least one shared marketing message for such at least one topic to such at least one second member by such at least one first member; and
e) accepting such at least one invitation to participate in such at least one scheduled delivery of such at least one shared marketing message for such at least one topic by such at least one second member.

10) The collaborative marketing management system according to claim 2 further comprising the steps of:
a) preparing at least one initiative agreement for each such at least one scheduled delivery of such at least one shared marketing message for such at least one topic;
b) wherein such at least one initiative agreement comprises
i) at least one schedule of completion dates of at least one manager task,
ii) at least one schedule of completion dates of at least one first member task,
iii) at least one schedule of completion dates of at least one second member task,
iv) at least one calculation basis for amount due from such at least one participating second member,
v) at least one amount due from such at least one participation second member, and
vi) at least one benefit amount due to such at least one first member;
c) agreeing to complete such at least one first member task by such at least one first member;
d) agreeing to complete such at least one second member task by such at least one second member; and
e) agreeing to complete such at least one manager task by such at least one manager.

11) The collaborative marketing management system according to claim 10 further comprising the steps of:
a) providing marketing calendar planning assistance to such at least one first member by such at least one manager;
b) providing design assistance for at least one first marketing message by such at least one manager;
c) providing design assistance for at least one second marketing message by such at least one manager; and
d) managing completion of such at least one initiative agreement by such at least one manager.

12) The collaborative marketing management system according to claim 11 wherein the step of approving such received marketing agreements, wherein members are determinable, comprises the steps of:
a) approving agreeing to comply with at least one manager requirement by at least one manager of such at least one managed collaborative marketing business;
b) wherein such at least one manager requirement comprises maintaining all such known proposed recipients of such at least one member as confidential, and
c) approving agreeing to comply with at least one member requirement by such at least one potential member;
d) wherein such at least one member requirement comprises
i) permitting the use of at least one creative element by such at least one manager,
ii) agreement to comply with at least one requirement of at least one such initiative agreement.

13) The collaborative marketing management system according to claim 2 wherein the step of combining such at least one first marketing message and such at least one second marketing message into such at least one shared marketing message is completed by such at least one manager.

14) The collaborative marketing management system according to claim 2 wherein the step of sending such at least one shared marketing message to such at least one plurality of recipients is completed by such at least one manager.

15) The collaborative marketing management system according to claim 2 wherein the step of sending such at least one shared marketing message to such at least one plurality of recipients is completed by such at least one first member.

16) The collaborative marketing management system according to claim 1 further comprising the step of receiving payment of at least one initial registration fee each from such at least one plurality of potential members.

17) The collaborative marketing management system according to claim 1 wherein such at least one managed collaborative marketing business is regionally organized.

18) A collaborative marketing management system relating to computer-managing at least one managed collaborative marketing business, comprising in combination:
a) computer interface means for acquiring at least one profile from at least one plurality of potential members;
b) computer interface means for permitting at least one first such identity-known member to send at least one shared marketing message, shared with at least one other second member, to at least one plurality of proposed recipients; and
c) computer interface means for permitting at least one sharing second member desiring to join such at least one shared marketing message to be sent to such at least one plurality of proposed recipients.

19) The collaborative marketing management system according to claim 18 further comprising:
a) computer interface means for receiving at least one marketing calendar from such at least one first member;
b) wherein such at least one marketing calendar comprises:
i) at least one topic of such at least one shared marketing message, and
ii) at least one scheduled delivery of such at least one shared marketing message for such at least one topic;
c) computer processor means for acquiring at least one first marketing message from such at least one first member;
d) computer processor means for acquiring at least one second marketing message from such at least one sharing second member;
e) computer processor means for combining such at least one first marketing message and such at least one second marketing message into such at least one shared marketing message;
f) computer processor means for selecting such at least one plurality of recipients of such at least one shared marketing message from such at least one plurality of proposed recipients; and
g) computer communication means for sending such at least one shared marketing message to such at least one plurality of recipients.

20) The collaborative marketing management system according to claim 19 further comprising:
a) computer processor means for calculating at least one amount to be paid by such at least one participating second member;
b) computer processor means for calculating at least one benefit amount attributable to such at least one first member; and
c) computer storage means for storing such at least one calculated amount from such at least one participating second member.

21) The collaborative marketing management system according to claim 19 further comprising:
a) computer processor means for recording the number of such at least one shared marketing messages sent;
b) computer processor means for recording the number of sent such at least one shared marketing messages responded to by such at least one recipient;
c) computer processor means for recording the number of sent such at least one first marketing messages responded to by such at least one recipient;
d) computer processor means for recording the number of sent such at least one second marketing messages responded to by such at least one recipient;
e) computer processor means for reporting to such at least one first member confidentially the number of such at least one first marketing messages responded to by such at least one recipient; and
f) computer processor means for reporting to such at least one second member confidentially the number of such at least one second marketing messages responded to by such at least one recipient.

22) The collaborative marketing management system according to claim 19 wherein such at least one plurality of recipients are entities known to such at least one first member.

23) The collaborative marketing management system according to claim 19 wherein such at least one plurality of recipients consist essentially of:
a) entities known to such at least one first member; or
b) entities known to such at least one second member; or
c) entities known to both such at least one first member and such at least one second member.

24) The collaborative marketing management system according to claim 19 wherein such at least one marketing calendar further comprises:
a) at least one count of estimated recipients of such at least one shared marketing message; and
b) identity of such at least one sharing second member.

25) The collaborative marketing management system according to claim 19 wherein such computer interface means for permitting at least one sharing second member desiring to join such at least one shared marketing message to be sent to such at least one plurality of proposed recipients comprises:
a) computer processor means for publishing such at least one marketing calendar of such at least one first member;
b) computer interface means for accepting requests to participate in such at least one scheduled delivery of such at least one shared marketing message for such at least one topic from such at least one second member;
c) computer interface means for selecting such at least one requesting second member for participation in such at least one scheduled delivery of such at least one shared marketing message for such at least one topic;
d) computer interface means for issuing at least one invitation to participate in such at least one scheduled delivery of such at least one shared marketing message for such at least one topic to such at least one second member by such at least one first member; and
e) computer interface means for accepting such at least one invitation to participate in such at least one scheduled delivery of such at least one shared marketing message for such at least one topic by such at least one second member.

26) The collaborative marketing management system according to claim 19 wherein such computer processor means for combining such at least one first marketing message and such at least one second marketing message into such at least one shared marketing message is controlled by such at least one manager.

27) The collaborative marketing management system according to claim 19 wherein such computer communication means for sending such at least one shared marketing message to such at least one plurality of recipients is controlled by such at least one manager.

28) The collaborative marketing management system according to claim 18 wherein such at least one managed collaborative marketing business is regionally organized.

29) A collaborative marketing management system computer program relating to computer-managing at least one managed collaborative marketing business, comprising the steps of:
a) storing at least one profile from at least one plurality of potential members;
b) authorizing at least one first such identity-known member to send at least one shared marketing message, shared with at least one other second member, to at a one plurality of proposed recipients; and
c) authorizing at least one sharing second member to join such at least one shared marketing message to be sent to such at least one plurality of proposed recipients.

30) The collaborative marketing management system computer program according to claim 29 further comprising the steps of:
a) storing at least one marketing calendar from such at least one first member;
b) wherein such at least one marketing calendar comprises:
i) at least one topic of such at least one shared marketing message, and
ii) at least one scheduled delivery of such at least one shared marketing message for such at least one topic;
c) storing at least one first marketing message from such at least one first member;
d) storing at least one second marketing message from such at least one sharing second member;
e) combining such at least one first marketing message and such at least one second marketing message into such at least one shared marketing message;
f) selecting such at least one plurality of recipients of such at least one shared marketing message from such at least one plurality of proposed recipients; and
g) sending such at least one shared marketing message to such at least one plurality of recipients.

31) The collaborative marketing management system computer program according to claim 30 further comprising the steps of:
a) calculating at least one amount to be paid by such at least one participating second member;
b) calculating at least one benefit amount attributable to such at least one first member; and
c) storing such at least one calculated amount from such at least one participating second member.

32) The collaborative marketing management system computer program according to claim 30, wherein such at least one shared marketing message comprises electronic mail, further comprising the steps of:
a) recording the number of such at least one shared marketing messages sent;
b) recording the number of sent such at least one shared marketing messages opened by such at least one recipient;
c) recording the number of sent such at least one first marketing messages responded to by such at least one recipient;
d) recording the number of sent such at least one second marketing messages responded to by such at least one recipient;
e) reporting to such at least one first member confidentially the number of such at least one first marketing messages responded to by such at least one recipient; and
f) reporting to such at least one second member confidentially the number of such at least one second marketing messages responded to by such at least one recipient.

33) The collaborative marketing management system computer program according to claim 30 wherein such at least one plurality of recipients are entities known to such at least one first member.

34) The collaborative marketing management system computer program according to claim 30 wherein such at least one plurality of recipients consists essentially of:
a) entities known to such at least one first member; or
b) entities known to such at least one second member; or
c) entities known to both such at least one first member and such at least one second member.

35) The collaborative marketing management system computer program according to claim 30 wherein such at least one marketing calendar further comprises:
a) at least one count of estimated recipients of such at least one shared marketing message; and
b) identity of such at least one sharing second member.

36) The collaborative marketing management system computer program according to claim 30 wherein such step of authorizing at least one sharing second member desiring to join such at least one shared marketing message to be sent to such at least one plurality of proposed recipients comprises the steps of:
a) presenting such at least one marketing calendar of such at least one first member;
b) accepting requests to participate in such at least one scheduled delivery of such at least one shared marketing message for such at least one topic from such at least one second member;
c) selecting such at least one requesting second member for participation in such at least one scheduled delivery of such at least one shared marketing message for such at least one topic;
d) issuing at least one invitation to participate in such at least one scheduled delivery of such at least one shared marketing message for such at least one topic to such at least one second member by such at least one first member; and
e) accepting such at least one invitation to participate in such at least one scheduled delivery of such at least one shared marketing message for such at least one topic by such at least one second member.

37) The collaborative marketing management system computer program according to claim 30, wherein such step of combining such at least one first marketing message and such at least one second marketing message into such at least one shared marketing message is controlled by such at least one manager.

38) The collaborative marketing management system computer program according to claim 30, wherein such step of sending such at least one shared marketing message to such at least one plurality of recipients is controlled by such at least one manager.
